(19) United States
(12) Patent Application Publication
(10) Pub. No.: US 2025/0301356 A1
(43) Pub. Date: Sep. 25, 2025

(54) CONFIGURING PARTICIPATION IN A RADIO SENSING OPERATION

(71) Applicant: Lenovo (Singapore) Pte. Ltd., Singapore (SG)

(72) Inventors: Seyedomid Taghizadeh Motlagh, Oberursel (DE); Ali Ramadan Ali, Kraiburg am Inn (DE); Karthikeyan Ganesan, Kronberg im Taunus (DE); Sher Ali Cheema, Ilmenau (DE)

(21) Appl. No.: 18/860,529

(22) PCT Filed: Apr. 25, 2023
(86) PCT No.: PCT/IB2023/054258

§ 371 Date: Oct. 25, 2024

Related U.S. Application Data
(60) Provisional application No. 63/334,621, filed on Apr. 25, 2022.

(51) Int. Cl. H04W 24/10; H04L 5/00; H04W 4/02

(52) U.S. Cl. CPC H04W 24/10; H04L 5/0051; H04W 4/02

(57) ABSTRACT

Apparatuses, methods, and systems are disclosed for configuring participation in a radio sensing operation. One method includes receiving, from a network node, a query message for a radio sensing operation, where the query message indicates a set of suitability conditions. The method includes determining whether the candidate device satisfies the set of suitability conditions and transmitting, to the network node, a response message to the network node based on the determination. The method includes receiving a sensing configuration for the radio sensing operation in response to the response message, the sensing configuration comprising one or more of: a configuration for radio sensing RS transmission, a configuration for radio sensing RS reception, or a configuration for radio sensing measurement report transmission. The method includes performing the radio sensing operation based on the sensing configuration.

### FIELD

The subject matter disclosed herein relates generally to wireless communications and more particularly relates to identifying a set of at least one communication device for participation in a radio sensing operation.

### BACKGROUND

A wireless communications system may include one or multiple network communication devices, such as base stations, which may be otherwise known as an evolved NodeB (“eNB”), a next-generation NodeB (“gNB”), or other suitable terminology. Each network communication devices, such as a base station may support wireless communications for one or multiple user communication devices, which may be otherwise known as user equipment (“UE”), or other suitable terminology. The wireless communications system may support wireless communications with one or multiple user communication devices by utilizing resources of the wireless communication system, e.g., time resources (e.g., symbols, slots, subframes, frames, or the like) or frequency resources (e.g., subcarriers, carriers). Additionally, the wireless communications system may support wireless communications across various radio access technologies including third generation (“3G”) Radio Access Technology (“RAT”), fourth generation (“4G”) RAT, fifth generation (“5G”) RAT, among other suitable RATs beyond 5G (e.g., sixth generation (“6G”)).

In certain embodiments, the wireless communication system may configure one or more network nodes to perform a radio sensing operation, e.g., to gather information about the radio environment in which the wireless communication network operates.

### BRIEF SUMMARY

The present disclosure relates to techniques for identifying UEs to participate in a radio sensing operation. Said techniques may be implemented by apparatus, systems, methods, or computer program products.

One method at a candidate device, such as a UE, includes receiving, from a network node, a query message for a radio sensing operation, wherein the query message indicates a set of suitability conditions. The method includes determining whether the candidate device satisfies the set of suitability conditions and transmitting, to the network node, a response message to the network node based on the determination. The method includes receiving a sensing configuration for the radio sensing operation, in response to the response message, and performing the radio sensing operation based on the sensing configuration. Here, the sensing configuration includes one or more of: a configuration for radio sensing reference signal (“RS”) transmission, a configuration for radio sensing RS reception, a configuration for radio sensing measurement report transmission, or a combination thereof.

One method at a network node device, such as a radio access network (“RAN”) node or a requesting UE, includes transmitting, to a plurality of candidate devices, a query message for a radio sensing operation, wherein the query message indicates a set of suitability conditions. The method includes receiving at least one response message from at least one of the plurality of candidate devices, each response message indicating a suitability of a particular candidate device for participation in the radio sensing operation. The method includes determining, based on the at least one response message, a set of devices to participate in the radio sensing operation. The method includes configuring the set of devices to participate in the radio sensing operation and performing the radio sensing operation.

### BRIEF DESCRIPTION OF THE DRAWINGS

FIG. 1 illustrates an example of a wireless communication system that supports techniques for configuring participation in a radio sensing operation, in accordance with aspects of the present disclosure;

FIG. 2 illustrates an example of a Third Generation Partnership Project (“3GPP”) New Radio (“NR”) protocol stack that supports different protocol layers in the UE and network, in accordance with aspects of the present disclosure;

FIG. 3A illustrates an example of a radio sensing scenario with RAN transmission, in accordance with aspects of the present disclosure;

FIG. 3B illustrates an example of a radio sensing scenarios with UE transmission, in accordance with aspects of the present disclosure;

FIG. 4 illustrates an example of a message sequence between a RAN entity and a candidate UE for radio sensing, in accordance with aspects of the present disclosure;

FIG. 5 illustrates an example of a message sequence between a requesting UE and a candidate UE for sidelink (“SL”) radio sensing, in accordance with aspects of the present disclosure;

FIG. 6 illustrates an example of a UE apparatus that supports techniques for configuring participation in a radio sensing operation, in accordance with aspects of the present disclosure;

FIG. 7 illustrates an example of a network equipment (“NE”) apparatus that supports techniques for configuring participation in a radio sensing operation, in accordance with aspects of the present disclosure;

FIG. 8 illustrates a flowchart of one method that supports techniques for configuring participation in a radio sensing operation, in accordance with aspects of the present disclosure; and

FIG. 9 illustrates a flowchart of another method that supports techniques for configuring participation in a radio sensing operation, in accordance with aspects of the present disclosure.

### DETAILED DESCRIPTION

The present disclosure describes systems, methods, and apparatus that support techniques for configuring participation in a radio sensing operation, in accordance with aspects of the present disclosure. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described techniques.

Radio sensing is expected to appear in future cellular wireless networks, both as a mechanism to improve the network performance, as well as an enabler to serve vertical use-cases. Radio sensing obtains environment information by the means of: i) transmission of a sensing excitation signal, e.g., a sensing RS, from a network or UE entity, hereafter termed as sensing Tx node; ii) reception of the reflections/echoes of the transmitted sensing excitation signal from the environment by a network or a UE entity, hereafter termed as sensing Rx node; and iii) processing of the received reflections and inferring relevant information from the environment.

In addition to the scenarios where network entities act as the sensing Tx nodes and sensing Rx nodes, the scenarios of UE-based and/or UE-assisted sensing are of high interest, especially when the intended environment feature/information is used to enable a service at the same UE node. Furthermore, given the high-density presence of UE in most environments of interest, UE assisted sensing enables the use of distributed computation and energy resources of the UE nodes, as well as the more diverse and short-distance sensing coverage for sensing targets of interest. Example related use-cases include, but not limited to, the need to detect potential physical obstacles and relative positioning is needed with respect to a known reference/entity, e.g., when UE location cannot be obtained via the available procedures. Detection examples include (but are not limited to) walking/movement assistance for a person with impaired vision, walking/movement assistance for a person walking in a low-visibility environment, presence detection (e.g., of an object in close proximity of the detecting device), surveillance (e.g., monitoring) of elder people and/or children, and detection of humans in a vehicle.

In view of the above-mentioned use-cases, the identification of the appropriate sensing scenario, i.e., identification of the UE nodes that may act as a sensing Tx node or sensing Rx node for a specific sensing task is non-trivial, considering limited UE computation, memory storage and energy resource, limited synchronization precision, as well as UE mobility and non-deterministic location with respect to an object/area of interest.

The current disclosure describes solutions to enable the determination of the appropriate UE nodes for sensing assistance in a communication network. In particular, solutions are disclosed for identifying the appropriate UE nodes for participation in a network-based radio sensing task, and/or identifying the appropriate UE nodes for participation in a SL-based radio sensing task.

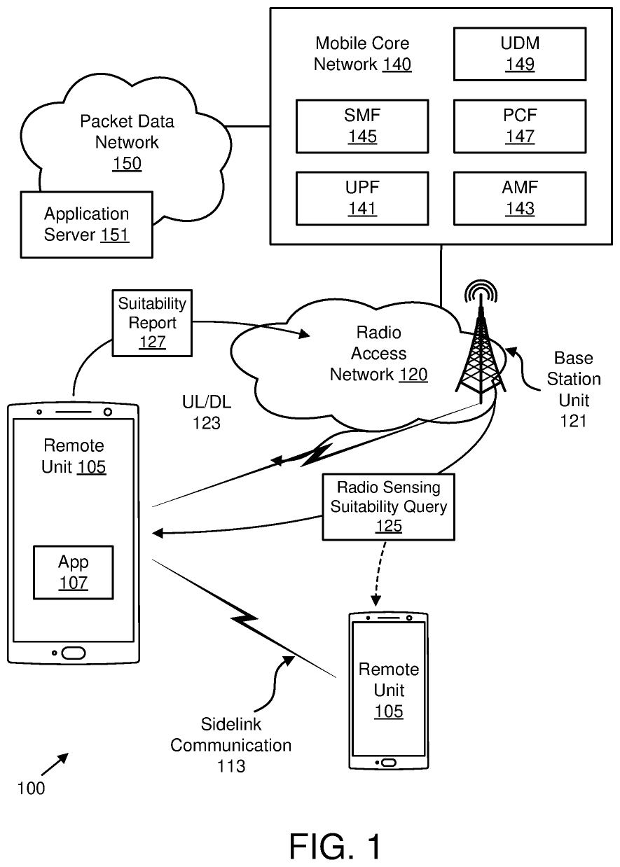

FIG. 1 illustrates an example of a wireless communication system 100 supporting techniques for configuring participation in a radio sensing operation, in accordance with aspects of the present disclosure. The wireless communications system 100 may support various radio access technologies. In some implementations, the wireless communications system 100 may be a 4G network, such as a Long-Term Evolution (“LTE”) network or an LTE-Advanced (“LTE-A”) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (“IEEE”) 802.11 (i.e., Wi-Fi), IEEE 802.16 (i.e., WiMAX), IEEE 802.20. The wireless communications system 100 may support radio access technologies beyond 5G. Additionally, the wireless communications system 100 may support technologies, such as time division multiple access (“TDMA”), frequency division multiple access (“FDMA”), or code division multiple access (“CDMA”), etc.

In one embodiment, the wireless communication system 100 includes at least one remote unit 105, a RAN 120, and a mobile core network 140. The RAN 120 and the mobile core network 140 form a mobile communication network. The RAN 120 may be composed of at least one base station unit 121 with which the remote unit 105 communicates using wireless communication links 123. Even though a specific number of remote units 105, RANs 120, base station units 121, wireless communication links 123, and mobile core networks 140 are depicted in FIG. 1, one of skill in the art will recognize that any number of remote units 105, RANs 120, base station units 121, wireless communication links 123, and mobile core networks 140 may be included in the wireless communication system 100.

In one implementation, the RAN 120 is compliant with the 5G cellular system specified in the 3GPP specifications. For example, the RAN 120 may be a Next Generation Radio Access Network (“NG-RAN”), implementing NR Radio Access Technology (“RAT”) and/or LTE RAT. In another example, the RAN 120 may include non-3GPP RAT (e.g., Wi-Fi® or IEEE 802.11-family compliant wireless local area network (“WLAN”)). In another implementation, the RAN 120 is compliant with the LTE system specified in the 3GPP specifications. More generally, however, the wireless communication system 100 may implement some other open or proprietary communication network, for example, the Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base station units 121 in the RAN 120 via uplink (“UL”) and downlink (“DL”) communication signals. Furthermore, the UL and DL communication signals may be carried over the wireless communication links 123. Furthermore, the UL communication signals may comprise one or more UL channels, such as the Physical Uplink Control Channel (“PUCCH”) and/or Physical Uplink Shared Channel (“PUSCH”), while the DL communication signals may comprise one or more DL channels, such as the Physical Downlink Control Channel (“PDCCH”) and/or Physical Downlink Shared Channel (“PDSCH”). Here, the RAN 120 is an intermediate network that provides the remote units 105 with access to the mobile core network 140.

In various embodiments, the remote unit 105 receives a radio sensing suitability query 125. In the depicted embodiment, the base station unit 121 transmits the radio sensing suitability query 125 to one or more candidate remote units 105. In other embodiments, a requesting remote unit 105 may send the radio sensing suitability query 125 to one or more candidate remote units 105 via SL communication 113.

The remote unit 105 evaluates one or more suitability criteria for participation in a radio sensing operation and transmits a suitability report 127. In the depicted embodiments, the remote unit 105 transmits the suitability report 127 to the same base unit that sent the radio sensing suitability query 125. However, in other embodiments, the remote unit 105 transmits the suitability report 127 to the same requesting remote unit 105 that sent the radio sensing suitability query 125. The contents of the radio sensing suitability query 125 and the suitability report 127 are described in greater detail below, as well as triggers and messaging sequences related to the radio sensing suitability query 125 and the suitability report 127.

In various embodiments, the remote units 105 may communicate directly with each other (e.g., device-to-device communication) using SL communication 113. The SL communication 113 may comprise one or more SL channels, such as the Physical Sidelink Control Channel (“PSCCH”), the Physical Sidelink Shared Channel (“PSSCH”) and/or the Physical Sidelink Feedback Channel (“PSFCH”). In various embodiments, the SL communication 113 relates to one or more services requiring SL connectivity, such as Vehicle-to-everything (“V2X”) services and ProSe services. A remote unit 105 may establish one or more SL connections with nearby remote units 105. For example, a V2X application 107 running on a remote unit 105 may generate data relating to a V2X service and use a SL connection to transmit the V2X data to one or more nearby remote units 105.

The SL communications 113 may occur on SL communication resources. A remote unit 105 may be provided with different SL communication resources according to different allocation modes. For example, in 3GPP systems, allocation Mode-1 corresponds to a NR-based network-scheduled SL communication mode, wherein the in-coverage RAN 120 indicates communication resources for use in SL operation, including the communication resources of one or more resource pools. Allocation Mode-2 corresponds to a NR-based UE-scheduled SL communication mode (i.e., UE-autonomous selection), where the remote unit 105 selects a resource pool and resources therein from a set of candidate pools. Allocation Mode-3 corresponds to an LTE-based network-scheduled SL communication mode. Allocation Mode-4 corresponds to an LTE-based UE-scheduled SL communication mode (i.e., UE-autonomous selection).

As used herein, a “resource pool” refers to a set of communication resources assigned for SL operation. A resource pool consists of a set of RBs (i.e., Physical Resource Blocks (“PRBs”)) over one or more time units (e.g., subframe, slots, Orthogonal Frequency Division Multiplexing (“OFDM”) symbols). In some embodiments, the set of RBs comprises contiguous PRBs in the frequency domain. A Physical Resource Block (“PRB”), as used herein, consists of twelve consecutive subcarriers in the frequency domain. In certain embodiments, a UE may be configured with separate transmission resource pools (“Tx RPs”) and reception resource pools (“Rx RPs”), where the Tx RP of one UE is associated with an Rx RP of another UE to enable the SL communications 113.

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a Protocol Data Unit (“PDU”) session (or Packet Data Network (“PDN”) connection) with the mobile core network 140 via the RAN 120. The PDU session represents a logical connection between the remote unit 105 and the User Plane Function (“UPF”) 141. The mobile core network 140 then relays traffic between the remote unit 105 and the application server 151 in the packet data network 150 using the PDU session (or other data connection).

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QOS Identifier (“5QI”).

In the context of a 4G/LTE system, such as the Evolved Packet System (“EPS”), a PDN connection (also referred to as EPS session) provides E2E UP connectivity between the remote unit and a PDN. The PDN connectivity procedure establishes an EPS Bearer, i.e., a tunnel between the remote unit 105 and a PDN Gateway (“PGW”) (not shown in FIG. 1) in the mobile core network 140. In certain embodiments, there is a one-to-one mapping between an EPS Bearer and a QoS profile, such that all packets belonging to a specific EPS Bearer have the same QoS Class Identifier (“QCI”).

The base station units 121 may be distributed over a geographic region. In certain embodiments, a base station unit 121 may also be referred to as an access terminal, an access point, a base, a base station, a Node-B (“NB”), an Evolved Node B (abbreviated as eNodeB or “eNB.” also known as Evolved Universal Terrestrial Radio Access Network (“E-UTRAN”) Node B), a 5G/NR Node B (“gNB”), a Home Node-B, a relay node, a RAN node, or by any other terminology used in the art. The base station units 121 are generally part of a RAN, such as the RAN 120, that may include one or more controllers communicably coupled to one or more corresponding base station units 121. These and other elements of radio access network are not illustrated but are well known generally by those having ordinary skill in the art. The base station units 121 connect to the mobile core network 140 via the RAN 120.

The base station units 121 may serve a number of remote units 105 within a serving area, for example, a cell or a cell sector, via a wireless communication link 123. The base station units 121 may communicate directly with one or more of the remote units 105 via communication signals. Generally, the base station units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base station units 121.

Note that during NR operation on unlicensed spectrum (referred to as “NR-U”), the base station unit 121 and the remote unit 105 communicate over unlicensed (i.e., shared) radio spectrum. Similarly, during LTE operation on unlicensed spectrum (referred to as “LTE-U”), the base station unit 121 and the remote unit 105 also communicate over unlicensed (i.e., shared) radio spectrum.

In one embodiment, the mobile core network 140 is a 5G Core network (“5GC”) or an Evolved Packet Core (“EPC”), which may be coupled to a packet data network 150, such as the Internet and private data networks, among other data networks. A remote unit 105 may have a subscription or other account with the mobile core network 140. In various embodiments, each mobile core network 140 belongs to a single mobile network operator (“MNO”) and/or Public Land Mobile Network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM”) and a User Data Repository (“UDR”). In some embodiments, the UDM is co-located with the UDR, depicted as combined entity “UDM/UDR” 149. Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (“DN”), in the 5G architecture. The AMF 143 is responsible for termination of Non-Access Stratum (“NAS”) signaling, NAS ciphering and integrity protection, registration management, connection management, mobility management, access authentication and authorization, security context management. The SMF 145 is responsible for session management (i.e., session establishment, modification, release), remote unit (i.e., UE) Internet Protocol (“IP”) address allocation and management, DL data notification, and traffic steering configuration of the UPF 141 for proper traffic routing.

The PCF 147 is responsible for unified policy framework, providing policy rules to CP functions, access subscription information for policy decisions in UDR. The UDM is responsible for generation of Authentication and Key Agreement (“AKA”) credentials, user identification handling, access authorization, and subscription management. The UDR is a repository of subscriber information and may be used to service a number of network functions. For example, the UDR may store subscription data, policy-related data, subscriber-related data that is permitted to be exposed to third party applications, and the like.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the 5GC. When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“cMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for case of illustration, but their support is assumed.

While FIG. 1 illustrates components of a 5G RAN and a 5G core network, the described embodiments for configuring participation in a radio sensing operation apply to other types of communication networks and RATs, including IEEE 802.11 variants, Global System for Mobile Communications (“GSM”) (i.e., a 2G digital cellular network), General Packet Radio Service (“GPRS”), Universal Mobile Telecommunications System (“UMTS”), LTE variants, CDMA2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “RAN node” is used for the base station/base station unit, but it is replaceable by any other radio access node or entity, e.g., gNB, ng-eNB, eNB, Base Station (“BS”), Access Point (“AP”), NR BS, 5G NB, Transmission and Reception Point (“TRP”), base unit, etc. Additionally, the term “UE” is used for the mobile station/remote unit, but it is replaceable by any other remote device, e.g., remote unit, MS, ME, etc. Further, the operations are described mainly in the context of 5G NR. However, the below described solutions/methods are also equally applicable to other mobile communication systems for configuring participation in a radio sensing operation.

In the following, instead of “slot,” the terms “mini-slot,” “subslot,” or “aggregated slots” can also be used, wherein the notion of slot/mini-slot/sub-slot/aggregated slots can be described as defined in 3GPP Technical Specification (“TS”) 38.211, TS 38.213, and/or TS 38.214.

Several solutions to configure participation in a radio sensing operation are described below. According to a possible embodiment, one or more elements or features from one or more of the described solutions may be combined.

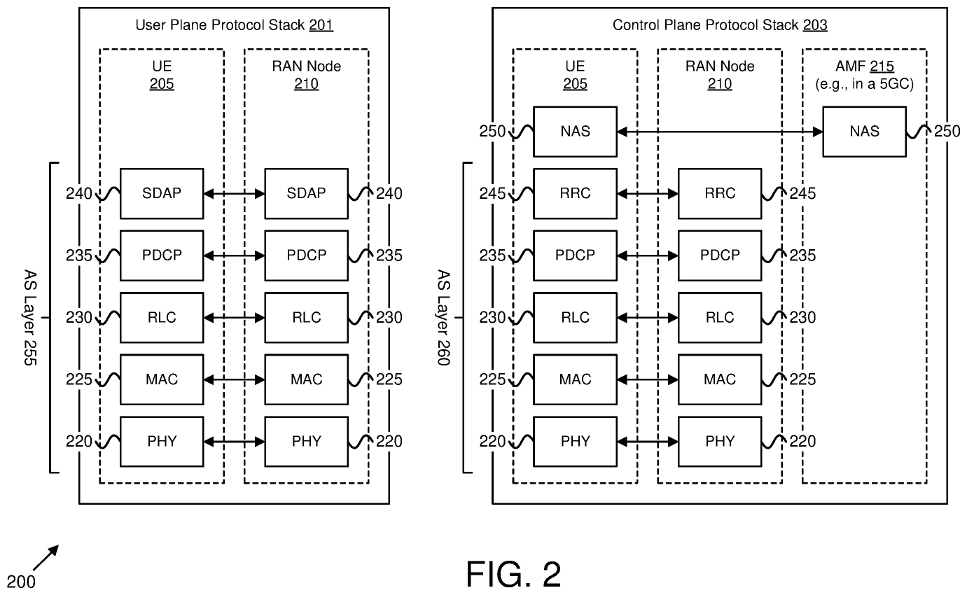

FIG. 2 illustrates an example of an NR protocol stack 200, in accordance with aspects of the present disclosure. While FIG. 2 shows the UE 205, the RAN node 210 and an AMF 215, e.g., in a 5GC, these are representatives of a set of remote units 105 interacting with a base station unit 121 and a mobile core network 140. As depicted, the NR protocol stack 200 comprises a User Plane protocol stack 201 and a Control Plane protocol stack 203. The User Plane protocol stack 201 includes a physical (“PHY”) layer 220, a Medium Access Control (“MAC”) sublayer 225, the Radio Link Control (“RLC”) sublayer 230, a Packet Data Convergence Protocol (“PDCP”) sublayer 235, and Service Data Adaptation Protocol (“SDAP”) sublayer 240. The Control Plane protocol stack 203 includes a PHY layer 220, a MAC sublayer 225, an RLC sublayer 230, and a PDCP sublayer 235. The Control Plane protocol stack 203 also includes a Radio Resource Control (“RRC”) layer 245 and a NAS layer 250.

The Access Stratum (“AS”) layer 255 (also referred to as “AS protocol stack”) for the User Plane protocol stack 201 is comprised by at least SDAP, PDCP, RLC and MAC sublayers, and the PHY layer 220. The AS layer 260 for the Control Plane protocol stack 203 is comprised of at least the RRC, PDCP, RLC and MAC sublayers, and the PHY layer 220. The Layer-1 (“L1”) comprises the PHY layer 220. The Layer-2 (“L2”) is split into the SDAP sublayer 240, PDCP sublayer 235, RLC sublayer 230, and MAC sublayer 225. The Layer-3 (“L3”) includes the RRC layer 245 and the NAS layer 250 for the control plane and includes, e.g., an IP layer and/or PDU Layer (not shown in FIG. 1) for the user plane. L1 and L2 are referred to as “lower layers,” while L3 and above (e.g., transport layer, application layer) are referred to as “higher layers” or “upper layers.”

The PHY layer 220 offers transport channels to the MAC sublayer 225. The PHY layer 220 may perform a Clear Channel Assessment (“CCA”) and/or Listen-Before-Talk (“LBT”) procedure using energy detection thresholds. In certain embodiments, the PHY layer 220 may send an indication of beam failure to a MAC entity at the MAC sublayer 225. In certain embodiments, the PHY layer 220 may send a notification of Listen-Before-Talk (“LBT”) failure to a MAC entity at the MAC sublayer 235. The MAC sublayer 225 offers logical channels to the RLC sublayer 230. The RLC sublayer 230 offers RLC channels to the PDCP sublayer 235. The PDCP sublayer 235 offers radio bearers to the SDAP sublayer 240 and/or RRC layer 245. The SDAP sublayer 240 offers QoS flows to the core network (e.g., 5GC). The RRC layer 245 provides functions for the addition, modification, and release of Carrier Aggregation and/or Dual Connectivity. The RRC layer 245 also manages the establishment, configuration, maintenance, and release of Signaling Radio Bearers (“SRBs”) and Data Radio Bearers (“DRBs”).

The NAS layer 250 is between the UE 205 and an AMF 215 in the 5GC. NAS messages are passed transparently through the RAN. The NAS layer 250 is used to manage the establishment of communication sessions and for maintaining continuous communications with the UE 205 as it moves between different cells of the RAN. In contrast, the AS layers 255 and 260 are between the UE 205 and the RAN (i.e., RAN node 210) and carry information over the wireless portion of the network. While not depicted in FIG. 2, the IP layer exists above the NAS layer 250, a transport layer exists above the IP layer, and an application layer exists above the transport layer.

The MAC sublayer 225 is the lowest sublayer in the L2 architecture of the NR protocol stack. Its connection to the PHY layer 220 below is through transport channels, and the connection to the RLC sublayer 230 above is through logical channels. The MAC sublayer 225 therefore performs multiplexing and demultiplexing between logical channels and transport channels: the MAC sublayer 225 in the transmitting side constructs MAC PDUs (also known as transport blocks (“TBs”)) from MAC Service Data Units (“SDUs”) received through logical channels, and the MAC sublayer 225 in the receiving side recovers MAC SDUs from MAC PDUs received through transport channels.

The MAC sublayer 225 provides a data transfer service for the RLC sublayer 230 through logical channels, which are either control logical channels which carry control data (e.g., RRC signaling) or traffic logical channels which carry user plane data. On the other hand, the data from the MAC sublayer 225 is exchanged with the PHY layer 220 through transport channels, which are classified as UL or DL. Data is multiplexed into transport channels depending on how it is transmitted over the air.

The PHY layer 220 is responsible for the actual transmission of data and control information via the air interface, i.e., the PHY layer 220 carries all information from the MAC transport channels over the air interface on the transmission side. Some of the important functions performed by the PHY layer 220 include coding and modulation, link adaptation (e.g., Adaptive Modulation and Coding (“AMC”)), power control, cell search and random access (for initial synchronization and handover purposes) and other measurements (inside the 3GPP system (i.e., NR and/or LTE system) and between systems) for the RRC layer 245. The PHY layer 220 performs transmissions based on transmission parameters, such as the modulation scheme, the coding rate (i.e., the modulation and coding scheme (“MCS”)), the number of Physical Resource Blocks (“PRBs”), etc.

In some embodiments, the UE 205 may support an LTE protocol stack. Note that an LTE protocol stack comprises similar structure to the NR protocol stack 200, with the differences that the LTE protocol stack lacks the SDAP sublayer 240 in the AS layer 255 and that the NAS layer 250 is between the UE 205 and an MME in the EPC.

Regarding UE capability for radio sensing, the features defining UE capabilities for sensing, where UE acts as a sensing Tx node for a sensing task associated with a sensing RS is defined via the set of the supported sensing RS patterns, may include (but are not limited to): A) The supported time-domain resource pattern for sensing RS, e.g., the maximum supported length of the sensing RS in time domain, maximum number of symbols or symbol density for sensing RS transmission, maximum supported power/energy for sensing RS transmission; B) The supported frequency-domain resource pattern for sensing RS, e.g., the maximum supported bandwidth of the sensing RS in frequency domain, maximum number of REs or RE density for sensing RS transmission, maximum supported power/energy for sensing RS transmission within a symbol or slot or a radio frame; C) The supported joint time-frequency domain resource pattern for sensing RS, e.g., the maximum supported number of total REs per radio frame for sensing RS transmission, maximum supported power/energy for sensing RS transmission within a symbol or a slot or a radio frame, the supported frequency hopping patterns; D) The supported spatial filters or beams or maximum supported number of simultaneously used spatial beams for sensing RS transmission; E) The supported guard interval or Cyclic Prefix (“CP”) overhead for sensing symbols within sensing RS transmission; F) The supported computation/determination for choosing the sensing RS resource pattern among a set of possible patterns for sensing RS transmission; G) The supported computation/determination methods for choosing the sensing RS sequence among a set of possible sequences for sensing RS transmission; H) The supported sequence generation strategies or the supported sets of sequence-generation defining parameters for sensing RS transmission; and/or I) The supported sequence-to-resources mapping-defining parameter set for sensing RS pattern generation for transmission.

The features defining UE capabilities for sensing, where UE acts as a sensing Rx node for a sensing task associated with a sensing RS is defined via the set of the supported sensing RS patterns, may include (but are not limited to): A) The supported time-domain resource pattern for sensing RS reception, e.g., the maximum supported length of the sensing RS in time domain, maximum number of symbols or symbol density for sensing RS reception; B) The supported frequency-domain resource pattern for sensing RS reception, e.g., the maximum supported bandwidth of the sensing RS in frequency domain, maximum number of REs or RE density for sensing RS reception; C) The supported joint time-frequency domain resource pattern for sensing RS reception, e.g., the maximum number of total REs per radio frame for sensing RS reception, the supported frequency hopping patterns for sensing RS reception; D) The supported spatial filters or beams or maximum number of simultaneously used spatial beams for sensing RS reception; E) The supported guard interval or CP overhead for sensing symbols within sensing RS reception; F) The supported detection/determination for a (partially) unknown received sensing RS resource pattern among a set of possible patterns for sensing RS reception; G) The supported detection/determination for a (partially) unknown received sensing RS sequence among a set of possible sequences; H) The supported sequence generation strategies for sensing RS transmission; and/or I) The supported sequence-to-resources mapping-defining parameter set for sensing RS reception.

The features defining UE capabilities for sensing, where UE acts jointly as a sensing Rx node and sensing Tx node (in a full-duplex fashion with simultaneous transmission and reception) for a sensing task associated with a sensing RS is defined via the set of the supported sensing RS patterns, may include (but are not limited to): A) The supported time-domain resource pattern for sensing RS joint transmission and reception; B) The supported frequency-domain resource pattern for sensing RS joint transmission and reception; C) The supported joint time/frequency-domain resource pattern including the supported frequency hopping patterns for sensing RS joint transmission and reception; D) The supported transmit and receive beam combinations for sensing RS joint transmission and reception; E) The supported transmit power, e.g., average transmit power during sensing, maximum average transmit power during sensing in any of the slots, maximum transmit power during any transmit symbol, total sensing RS energy, for sensing RS joint transmission and reception; F) The features for the supported transmit power for sensing which are defined specific to a transmit beam or Tx/Rx beam combination supported for joint sensing RS transmission and reception; and/or G) The features defining any allowed combination of the supported set of sensing RS for transmission and the supported set of sensing RS for reception.

The features defining UE capabilities for sensing RS multiplexing may include (but are not limited to): A) The number of sensing RS that can be multiplexed within the same radio frame, or exist at the same time (i.e., exist when other ones are started and before the other ones are ended); B) The type of data/control channels or other RSs that can coexist with a sensing RS (i.e., exist after the channel/RS starts and before the channel/RS ends); C) The support of Discrete Fourier Transform (“DFT”) spreading on the sensing RS, or the multiplexed sensing RS; and/or D) For all the above, the supported type of multiplexing.

The features defining UE capabilities for sensing measurements, where UE operates as sensing Rx node is defined via the set of supported measurement types, may include (but are not limited to): A) The supported methods or computational models for sensing measurement (e.g., time-domain processing for time-of-flight estimation, Cyclic Prefix OFDM (“CP-OFDM”) based doppler/range estimation, available computational/Artificial Intelligence (“AI”) models for sensing measurements); B) The support of distance/range estimation, supported dynamic range of the object distance for estimation, supported distance estimation resolution; C) The support of object speed estimation, supported dynamic range of the object speed for estimation, supported speed estimation resolution; D) The support of the angular estimation (e.g., Direction-of-Arrival (“DoA”) estimation), supported dynamic range of the DoA for estimation, supported DoA estimation resolution; E) The maximum number of simultaneously supported objects for sensing measurements; and/or F) Support of measurement features defined as the combination of any of the above features, e.g., support of DoA estimation for the objects with a specific distance dynamic range and a specific distance resolution.

The features defining UE capabilities for sensing measurements reporting, where UE operates as sensing Rx node is defined via the set of supported measurement reporting types, including (but not limited to): A) Type of the supported message/reporting (e.g., compression of the measurements or the estimated parameters or event-based reporting with a defined criterion); B) Duration that a measurement message can be stored by the UE before transmission/reporting; C) The supported reporting criterion (e.g., comparing an estimated distance with a threshold, or computational models for checking a reporting criteria); and/or D) Supported compression types for the reporting message.

The above UE capabilities are described in further detail in U.S. application Ser. No. 17/538,950 entitled “SENSING REFERENCE SIGNAL ADJUSTMENTS FOR USER EQUIPMENT PARTICIPATION” and filed on Nov. 30, 2021 for Seyedomid Taghizadeh Motlagh, Ali Ramadan Ali, Ankit Bhamri, Sher Ali Cheema, Razvan-Andrei Stoica, Hyejung Jung and Vijay Nangia, which application is incorporated herein by reference.

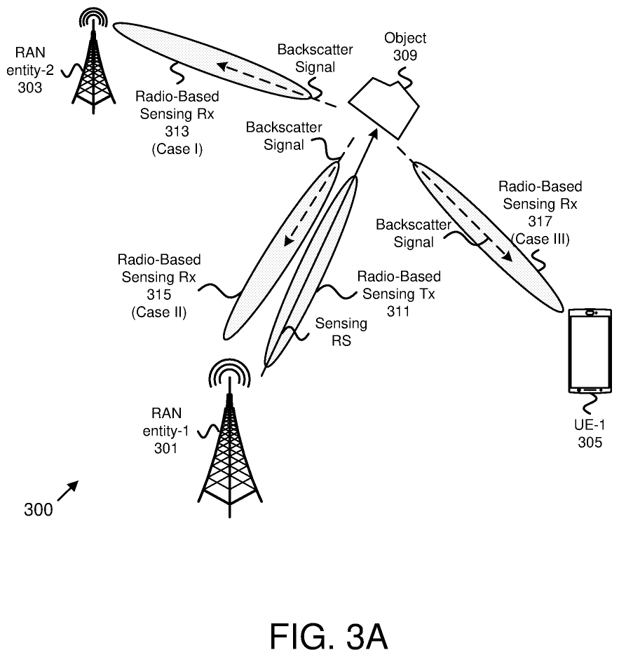

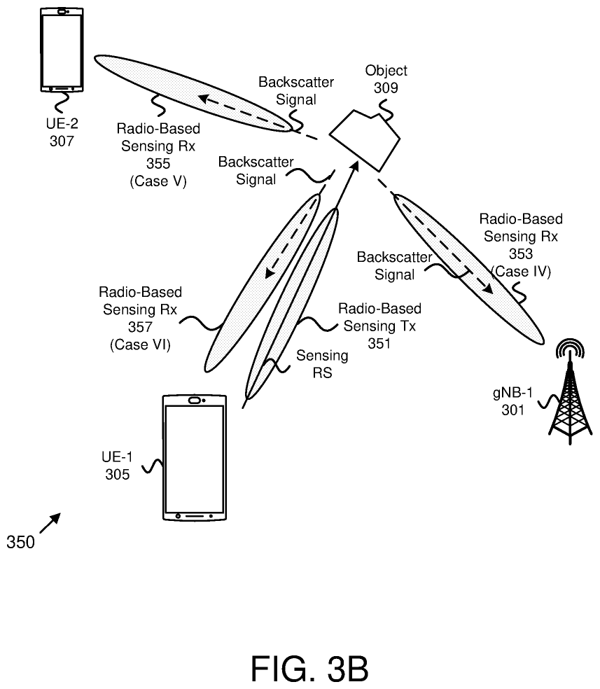

Regarding network-based and UE-based (i.e., SL-based) radio sensing operations, different scenarios for radio sensing are presented in FIGS. 3A and 3B. In some scenarios of radio sensing, the network configures the participating sensing entities, i.e., network and UE nodes acting as sensing Tx nodes, network and UE nodes acting as sensing Rx nodes, as well as the configuration of sensing RS and necessary measurements and reporting procedures from the nodes. In this regard, the functional split between the network and the UE nodes for a specific sensing task may take various forms, depending on the availability of sensing-capable devices and the requirements of the specific sensing operation.

FIG. 3A depicts possibilities for sensing scenarios for a radio sensing operation 300 where a RAN entity performs a sensing RS transmission, according to embodiments of the disclosure. In the scenarios of FIG. 3A, sensing RS reception is performed by one or more UEs, one or more RAN entities, or a combination thereof. The radio sensing operation 300 may involve a first RAN entity 301 (e.g., a gNB or network TRP node), a second RAN entity 303 (e.g., agNB or a network TRP node), and/or a set of at least one UE (represented by the first UE 305).

In various embodiments, the radio sensing operation 300 is used to detect and locate an object of interest 309. In general, a Radio-based sensing transmission 311 is performed by the first RAN entity 301. While the below examples describe the Radio-based sensing transmission 311 using a sensing reference signal (“sensing RS”), in other embodiments the Radio-based sensing transmission 311 may be a transmission of another RS or instead may be a transmission of the data/control channels known to the network TRP nodes.

In a first sensing scenario (also referred to herein as “Case I”), the Radio-based sensing transmission 311 is performed by a first network node (i.e., the first RAN entity 301) and the Radio-based sensing reception 313 is performed by a separate network node (i.e., the second RAN entity 303). In this case, the sensing RS (or another RS used for sensing) is transmitted and a reflection/backscatter signal is received by network entities. The network does not utilize UEs for sensing assistance in this scenario. Rather, the involvement of UE nodes (i.e., first UE 305) is limited to the aspects of interference management, when necessary.

In a second sensing scenario (also referred to herein as “Case II”), the Radio-based sensing transmission 311 is performed by a first network node (i.e., the first RAN entity 301) and the Radio-based sensing reception 315 is performed by the same network node. In this case, the sensing RS (or another RS used for sensing) is transmitted and a reflection/backscatter signal is received by the same network entity. The network does not utilize UEs for sensing assistance in this scenario. Rather, the involvement of UE nodes (i.e., first UE 305) is limited to the aspects of interference management, when necessary.

In a third sensing scenario (also referred to herein as “Case III”), the Radio-based sensing transmission 311 is performed by a first network node (i.e., the first RAN entity 301) and the Radio-based sensing reception 317 is performed by a UE node (i.e., the first UE 305). In this case, the sensing RS or other RS used for sensing is transmitted by a network entity and a reflection/backscatter signal is received by one or multiple UE nodes, including the first UE 305. The network configures the UEs to act as a sensing Rx node, according to the UE capabilities for sensing, as well as desired sensing task.

FIG. 3B depicts possibilities for sensing scenarios for a radio sensing operation 350 where a UE performs a sensing RS transmission, according to embodiments of the disclosure. In the scenarios of FIG. 3B, sensing RS reception is performed by one or more UEs, one or more RAN entities, or a combination thereof. The radio sensing operation 350 may involve the first UE 305, a set of at least one peer UE (represented by the second UE 307), and/or a set of at least one TRP (represented by the first RAN entity 301).

In various embodiments, the radio sensing operation 350 is used to detect and locate an object of interest 309. In general, a Radio-based sensing transmission 351 is performed by the first UE 305. While the below examples describe the Radio-based sensing transmission 351 using a sensing RS, in other embodiments the Radio-based sensing transmission 351 may be a transmission of another RS or instead may be a transmission of the data/control channels.

In a fourth sensing scenario (also referred to herein as “Case IV”), the Radio-based sensing transmission 351 is performed by a first UE 305 and the Radio-based sensing reception 353 is performed by a RAN entity (i.e., the first RAN entity 301). In this case, the sensing RS (or another RS transmitted for sensing) is transmitted by a UE node and a reflection/backscatter signal is received by one or multiple network entities. The network configures the transmitting UE (i.e., the first UE 305) to act as a sensing Tx node, according to the UE nodes' capabilities for sensing, as well as the nature of the desired sensing task.

In a fifth sensing scenario (also referred to herein as “Case V”), the Radio-based sensing transmission 351 is performed by a first UE 305 and the Radio-based sensing reception 355 is performed by a separate UE (i.e., the second UE 307). In this case, the sensing RS (or another RS transmitted for sensing) is transmitted by a UE node and a reflection/backscatter signal is received by one or multiple UE nodes. The network, or potentially the first UE 305, may decide on configuration of the sensing scenario. In one instance, the network configures the UEs to act as a sensing Tx node and/or sensing Rx nodes, according to the UE nodes capabilities for sensing, as well as the nature of the desired sensing task.

In a sixth sensing scenario (also referred to herein as “Case VI”), the Radio-based sensing transmission 351 is performed by a first UE 305 and the Radio-based sensing reception 357 is performed by the same UE. In this case, the sensing RS (or another RS transmitted for sensing) is transmitted by a UE node and a reflection/backscatter signal is received by the same UE node. The UE or the network configures the sensing scenario, according to the UE nodes capabilities for sensing, as well as the nature of the desired sensing task.

The above Radio sensing scenarios are described in further detail in U.S. application Ser. No. 17/538,978 entitled “CONFIGURING A SENSING REFERENCE SIGNAL” and filed on Nov. 30, 2021 for Seyedomid Taghizadeh Motlagh, Ali Ramadan Ali, Ankit Bhamri, Sher Ali Cheema, Razvan-Andrei Stoica, Hyejung Jung and Vijay Nangia, and also described in further detail in U.S. application Ser. No. 17/538,998 entitled “SENSING REFERENCE SIGNAL CONFIGURATION” and filed on Nov. 30, 2021 for Seyedomid Taghizadeh Motlagh, Ali Ramadan Ali, Ankit Bhamri, Sher Ali Cheema, Razvan-Andrei Stoica, Hyejung Jung and Vijay Nangia, which applications are incorporated herein by reference.

Regarding sensing Quality of Service (“QoS”), for a particular radio sensing task, the information elements defining the sensing QoS as well as the intended sensing information type are summarized as following:

The required/needed sensing information type by UE: in some embodiments, the type of the intended information to be obtained via a sensing procedure is included in the request message. This includes, e.g., indication of the need for object/blockage detection, material/composite estimation, tracking or ranging of an object of interest, and/or estimating the speed of an object of interest. In some embodiments, the needed information is defined explicitly in order to facilitate scheduling or a proper response determination by the network.

QoS of the needed sensing info: In some embodiments, the required QoS for the requested sensing information is included in the request message by UE. This may include all or any of (but is not limited to) the following sensing QoS information:

Latency: the tolerable latency requirement for the accomplishment of the requested sensing operation. The measurable time duration may be defined as the time-difference from the transmission of the request or reception of the request by the network, to the reception of the response from the network or reception of a sensing RS transmitted in response to the UE request, or accomplishment of the sensing procedure or reception/recovery of the intended sensing information by the UE.

Reliability/Accuracy: information on the accuracy of the obtained information defined via, e.g., tolerable probability of false alarm for detection within an object/area of interest, required probability of detection for detection within an object/area of interest, and/or the tolerable error measure on the envisioned parameter estimation, e.g., estimation of speed or distance of an object of interest.

Request importance: In some embodiments, an indication of the significance of the requested information is also included in the message, as a different/separate information element to the other QoS descriptions for sensing. This may, e.g., indicates the priority of the network for responding positively to the requested service. The UE may include, in the requesting message, a priority identifier/class for different types of requests.

Security/privacy: In some embodiments, the sensing operation is requested to accompany measures for protecting the envisioned (to be extracted) sensing information, any informative propagation/reflection from the object/area of interest that may be used by an unauthorized third-party. The type of the security measure, e.g., object-of-interest sensing information protection, area of interest sensing information protection, requesting-UE identity protection together with the level of required security, e.g., as an integer number defining the required security level, may be included in the request message.

The below described solutions enable and enhance the determination of the appropriate UE nodes for assistance in a network-based or a UE/SL-based sensing task via the following high-level solutions:

In a first solution, signaling of the messages and message sequence/procedure are defined for UE identification for sensing assistance.

In a second solution, a sensing suitability query message and response message are defined for the determination of the suitability of a UE for sensing in a network-based sensing scenario, for example, determining observation/illumination capability towards an object/area of interest.

In a third solution, a SL Sensing request message and response message are defined for the determination of suitability of the UE for sensing in a SL-based sensing scenario, for example, determining observation/illumination capability towards an object/area of interest.

According to embodiments of the first solution, the determination of the suitable network nodes (e.g., a group suitable UEs) for participation in a sensing task is accomplished based on the transmission of a query message, by a first network node, towards one or multiple network nodes as candidates network nodes (e.g., candidate UEs) for participation in a sensing task. The suitability query message elements may include, but are not limited to: A) one or more criteria for stationarity conditions of the candidate node for sensing with respect to a sensing target object/area of interest; B) one or more criteria for observability of the target object/area of interest for the candidate node for sensing; C) a sensing capability and readiness/availability of the candidate node for sensing participation, including energy, memory storage, processing capability or a combination thereof, related to a sensing task; and/or D) a combination of the above elements.

Subsequently, a candidate network node (e.g., candidate UE) for participating in a sensing task will respond to the query message, reporting on the candidate network node suitability for sensing. In one embodiment, the candidate network node responds when all suitability criteria are met. In another embodiment, the candidate network node responds when at least a subset of the suitability criteria is met. Here, the first network node may indicate the subset of suitability criteria that triggers the candidate network node to send a response message.

As a result of the transmitted query and the received response message, the first network node may perform one or more the following actions: A) refine the group of candidate network nodes for participating in the sensing task by eliminating the candidates which do not satisfy some suitability criterion, thereby building a new group of the candidate network nodes; B) assign an identifier number to the identified group of network nodes for sensing participation; C) determine a group of network nodes for sensing participation based on the received query and response messages; D) configure a sensing operation (i.e., where the identified network nodes participate in the sensing operation as sensing Tx node and/or sensing Rx node, or a combination thereof); and/or E) a combination of the above actions.

In some embodiments of the first solution, the transmission of the query message and the query message response, as well as the subsequent configurations of a radio sensing task are transmitted via the physical control/data channels.

According to embodiments of the second solution, the determination of the suitable UE nodes for participation in a network-based UE-assisted sensing task is done based on the transmission of a sensing suitability query message by the network towards one or multiple candidate UE nodes for participation in a sensing task. Subsequently, the candidate UE node for sensing will respond to the sensing suitability query message, reporting on the node suitability for sensing. As a result of the transmitted query and the received response, the network node may perform one or more of the following actions: A) refine the group of candidate UE nodes and construct a new group of candidate UE nodes for the sensing task; B) assign an identifier number to the identified group of UE nodes; C) configure a sensing operation on the identified group of UE nodes; and/or D) a combination thereof.

In some embodiments, the information elements within the sensing suitability query message and/or the sensing suitability response/report as well as the message sequence for the configuration and message exchange are defined via an element defined via the following.

It is understood that this embodiment is not limited to the implementation elements individually, and one or more elements from one or more implementations and/or embodiments may be combined.

Regarding the sensing suitability query for Network-based UE-assisted sensing, in order to facilitate UE assisted sensing, the network needs to identify the UE nodes for a specific sensing task which are properly positioned with respect to an object/area of interest. Here, the focus is to identify the UEs which are properly positioned and have the capability to observe the object/area of interest for an intended sensing task.

In some embodiments, the determination of the suitable UE nodes is done by sending a sensing suitability query message by the network towards a candidate UE or a group of candidate UEs that may participate in the sensing process. In response to the reception of the sensing suitability query message, a UE which satisfies the indicated conditions according to the sensing suitability query message transmits a response message (e.g., suitability report) to the network.

In some embodiments, upon transmission of the sensing suitability query message and reception of the sensing suitability query response message, the network may perform one or more of the following actions: A) schedule the identified UE for the associated sensing task; B) perform further adjustment on the identified candidate UEs; C) perform further test/verification for UE sensing suitability; and/or D) a combination thereof.

In one embodiment of the second solution, the sensing suitability query message includes the definition of the area of interest and/or location of the object of interest which is intended for sensing. This information may be presented within a known coordinate, e.g., a global coordinate system known to the UEs or presented to each UE within its local coordinate system, or via the indication of a previously known object/area of interest or defined relative to a known object/area of interest, or a combination thereof.

In some embodiments, the sensing suitability query may include the condition that the candidate sensing UE must enjoy a Line-of-Sight (“LoS”) condition towards an entity acting as the sensing Tx node. In some embodiments, a configuration for the determination of the LoS condition is included in the sensing suitability query message.

In some embodiments, the sensing suitability query may include the condition that the candidate sensing UE must enjoy a Non-Line-of-Sight (“NLoS”) reception on a specific beam (e.g., identified with an angle corresponding to the object/area of interest). In some embodiments, a configuration for the determination of the NLoS condition is included in the sensing suitability query message.

In some embodiments, the sensing suitability query message includes the required sensing QoS which has to be respected by the participating UE, or requirements on the related UE sensing measurements. This may include, but not limited to, the expected sensing time-duration, expected sensing mode by the UE including sensing Tx node, or sensing Rx node, or a combination thereof, the required sensing Tx node transmit power, the parameters related to the expected sensing RS and the expected processing/measurements on the sensing RS, the corresponding sensing QoS, or other UE capability elements related to sensing.

In another embodiment of the second solution, in order to facilitate a sensing task with UE assistance over a period of time, the sensing suitability query includes a time pattern for which the UE must satisfy some stationarity conditions according to the sensing suitability query.

In some embodiments, the stationarity condition includes for the UE to remain at the same position, or the same velocity, or the same orientation or a combination thereof for an indicated time window. In some embodiments, the stationarity condition is defined over one or multiple specific directions for position stationarity, one or multiple specific directions for velocity stationarity, one or multiple specific direction/angles for orientation stationarity, or some combinations thereof. In some embodiments, the stationarity condition includes one or multiple or separate thresholds to define the stationarity of location or velocity or orientation or a combination thereof along one or multiple defined directions. In some embodiments, the specific directions for position stationarity are defined within the UE local coordinate system or a known coordinated system to the UE.

In some embodiments, multiple stationarity conditions can be defined for the UE where each stationarity condition and the parameters defining the stationarity conditions may be defined separately or in relation to the other or previously defined stationary conditions.

In some embodiments, a stationarity condition may be defined as the UE capability maintaining a beam towards an area/angle/angular region of interest, within a defined period of time.

In some embodiments, the stationarity condition includes a defined time window in the past where the indicated stationarity condition is tested. In some embodiments, the stationarity condition includes an indicated statistical confidence margin, e.g., to satisfy the indicated stationarity condition within the X time window into the future with Y probability.

In some embodiments, the information regarding the LoS/NLoS condition of the candidate UE, the stationarity of a candidate UE, as well as other criterion defined related to the UE suitability for participation are defined with respect to a beam indicated with a Quasi-Co-Location (“QCL”) type-D relation with an RS known to all of the candidate UEs, a group of candidate UEs or to a single candidate UE or a combination thereof.

In some embodiments of the second solution, in response to the reception of the sensing suitability query message, a UE which satisfies the indicated conditions within the sensing suitability query message transmits a response message to the network.

In some embodiments, the response message includes the indication that the UE is determined to have the sensing capability and satisfies all the defined criteria, or only a subset of criteria is satisfied. In some embodiments, the UEs not having the sensing capability, or not satisfying a minimum subset of the criteria, do not send a report to the network.

In some embodiments, when UE capability for sensing is not determined, UE does not send a response to the network. In some embodiments, when UE capability for sensing is not determined, UE sends a response to the network including the set of criteria which are not met, the measurements report, or a combination thereof.

In some embodiments, a report on the performed measurements and other suitability-related values are transmitted to the network via the response message, according to the received configurations and the sensing suitability query message, where the network makes the determination of the UE suitability according to the received measurement report.

In some embodiments, only a subset of the above information elements is included in the request message. In some embodiments, the information embedded within the sensing suitability query message is indicated via an index from a codebook, where the codebook defines different possible values for the abovementioned information elements. In some embodiments, one or multiple codebooks for defining the sensing request information is available, where each codebook includes possible values for one or a subset of the information elements within the message. In some embodiments, codebooks defining the above information elements are defined in accordance with the envisioned use-cases that may be relevant for the UE application.

In some embodiments, the information elements within the request message are assumed to hold a default value, unless the value of the information element is explicitly or implicitly defined in the sensing suitability query message. In some embodiments, the possible/supported codebook entries for sensing suitability query message are transferred to the UE from the network. In some embodiments, the transfer of the supported codebook entries for sensing suitability query message is transmitted by the network to the UE upon indication of satisfying some relevant UE capabilities.

In some embodiments, upon the transmission of sensing suitability query and reception of the response by the network, the single UE or a group of UE devices are identified to participate, or may participate potentially, in a sensing task.

In some embodiments of the second solution, the known UL and DL physical channels to transmit data and/or control information within the network are used to convey the sensing suitability query message, the sensing suitability query message response, related configurations for the message/response, configurations for the needed measurements, as well as the measurements reports by the UE.

In some implementations, the RS used for the purpose of UE and/or beam identification/refinement for sensing is a sensing specific RS, sensing specific RS for DL (when the measurement RS is transmitted by the network), sensing specific RS for UL (when the measurement RS is transmitted by the candidate UEs) or an RS defined specifically for sensing UE/beam determination. In some embodiments, an existing RS is used for the purpose of UE and/or beam identification/refinement for sensing, where the RS configuration is done according to the parameters defining the used RS. In some embodiments, some of the parameters defining the used RS for the purpose of the sensing UE and determination are configured semi-statically (remain constant over multiple usage of the RS for related measurements) and others dynamically (changed according to each use-case).

In some implementations, the sensing suitability query message and/or the related measurements configuration is transmitted dynamically, via a Downlink Control Information (“DCI”) or a group common DCI, semi-statically via RRC message, or via a broadcast message, e.g., System Information Block (“SIB”). In some embodiments, the configuration for the sensing suitability query message, the type of the sensing suitability query message, the configuration for the sensing suitability query message response or a combination thereof are transmitted via RRC signaling, or a multicast signaling to a group of candidate UEs dynamically via DCI with Cyclic Redundancy Check (“CRC”) scrambled with a group-common Radio Network Temporary Identifier (“RNTI”), via individual DCI, or a broadcast signaling via a SIB, or via RRC signaling.

In some implementations, the associated measurement resources for sensing suitability determination and/or beam refinement are a semi-persistent resource configured via RRC signaling, with activation indicated via a MAC control element (“MAC-CE”) or an individual DCI indication or a group common DCI. In some embodiments, where the associated measurement resources configured via RRC signaling, the type of the required measurement, reporting configuration, and UE/beam determination strategy are indicated together with an activation MAC-CE or an individual DCI indication or a group common DCI, or a combination thereof.

In some implementations, the type/format of the sensing suitability query message is signaled to the UE dynamically, via a DCI or a group common DCI, semi-statically via RRC message, or via a broadcast message, e.g., SIB. In one implementation, this includes the indication of an index from a codebook, where the codebook includes the possible sensing suitability query message format.

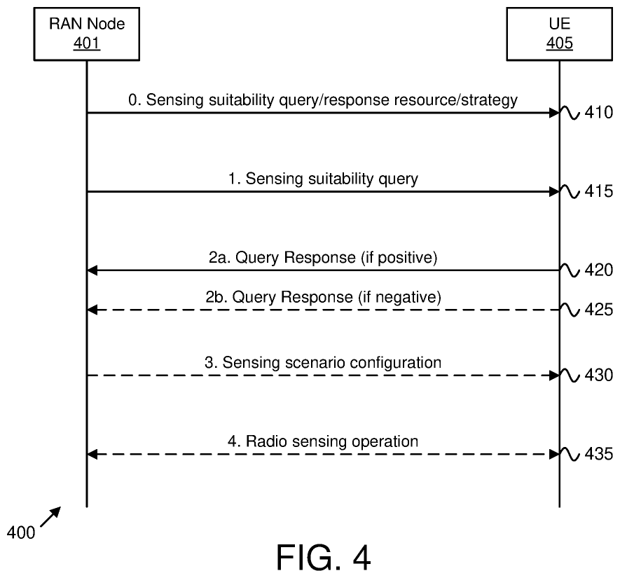

FIG. 4 depicts a message sequence 400 between a RAN node 401 (e.g., gNB or other RAN entity) and a candidate UE 405 for sensing. The dashed lines are messages which may be transmitted in the process for the proper UE/beam identification, whereas the solid lines are the messages which are necessary for establishing the sensing scenario.

At Step 0, the RAN node 401 sends a configuration to the UE 405 including one or more of resources for receiving the sensing suitability query, resources for transmitting the response, suitability determination strategy for participation in a radio sensing operation (see messaging 410).

At Step 1, the RAN node 401 sends a sensing suitability query message to the UE 405 (see messaging 415). The contents of the sensing suitability query may be as described herein.

At Step 2, the UE 405 evaluates one or more suitability criteria (also referred to herein as “suitability conditions”) and determines which criteria are met by the UE 405. Based on which criteria are met, the UE 405 may send a positive response to the RAN node 401 or may send a negative response to the RAN node 401.

At Step 2a, the UE 405 sends a positive Query Response message to the 401 (see messaging 420). In certain embodiments, the response includes the indication that the UE is determined to have the sensing capability and satisfies at least a minimum subset of the defined suitability criteria. In some embodiments, the response indicates that the UE satisfies all the defined suitability criteria. In other embodiments, the response indicates that the UE satisfies only a subset of the defined suitability criteria.

At optional Step 2b, the UE 405 sends a negative Query Response to the RAN node 401 (see messaging 425). In certain embodiments, the UE 405 may send a response to the network including the set of criteria which are not met. In other embodiments, the UEs not having the sensing capability, or not satisfying a minimum subset of the suitability criteria, do not send a report to the network.

At optional Step 3, the RAN node 401 may optionally send a sensing scenario configuration (also referred to as a configuration for participating in a radio sensing operation) to the UE 405 (see messaging 430). Here, the sensing scenario configuration may include one or more of: a configuration for radio sensing RS transmission, a configuration for radio sensing RS reception, and a configuration for radio sensing measurement report transmission.

At Step 4, the RAN node 401 and the UE 405 may participate in the radio sensing operation (see messaging 435), e.g., based on the configuration exchanged in step 3. For example, the RAN node 401 may transmit a sensing RS and the UE 405 may receive/measure the sensing RS and send a measurement report to the RAN node 401. In the depicted embodiment, it is assumed that the UE 405 meets at least a minimum subset of the suitability criteria and is thus selected to participate in the radio sensing operation. The message sequence 400 ends.

In some implementations, the type/format of the sensing suitability query message response is signaled to the UE to the UE dynamically, via a DCI or a group common DCI, semi-statically via RRC message, or via a broadcast message, e.g., SIB. In one implementation, this includes the indication of an index from a codebook, where the codebook includes the possible sensing suitability query message response formats. In some embodiments, the response message and/or the measurements report message are transmitted via an uplink control information element Uplink Control Information (“UCI”) via Physical Uplink Control Channel (“PUCCH”) or via PUSCH.

According to embodiments of the third solution, the determination of the suitable UE nodes for participation in a SL-based sensing task are done based on the transmission of a SL Sensing Request message by the network towards one or multiple candidate UE nodes for participation in the sensing task. Subsequently, the candidate UE node for SL sensing will respond to the SL Sensing Request message, reporting on the node suitability for sensing. As a result of the transmitted SL Sensing Request message and the received response, the requesting UE node for SL sensing may perform one or more of the following actions: A) refine the group of candidate UE nodes and construct a new group of candidate UE nodes for the sensing task; B) assign an identifier number to the identified group of UE nodes; C) configure a sensing operation on the identified group of UE nodes; and/or D) a combination thereof.

In some embodiments, the information elements within the sensing suitability query message and/or the sensing suitability query message response/report as well as the message sequence for the configuration and message exchange are defined via an element defined via the following.

It is understood that this embodiment is not limited to the implementation elements individually, and one or more elements from one or more implementations and/or embodiments may be combined.

In some embodiments, the UE transmits a SL Sensing Request message in SL towards other UEs as potential candidates for sensing participation, including an indication of a radio sensing request by the transmitting UE, as well as additional information assisting the determination of the suitable sensing UE.

In some embodiments, similar message format/structure and the information elements as for sensing suitability query message (sent by the network to the UE) and radio sensing request message (sent by UE to the network) or a combination or a subset thereof is included in the SL Sensing Request message.

In some embodiments, all or a combination of the information elements defined via the following embodiments are included in the SL Sensing Request message.

In one embodiment of the third solution, the SL Sensing Request message includes the type of the sensing operation expected from the other candidate UEs, including the indication of the sensing mode, such as sensing Tx mode or sensing Rx mode, the type of the sensing RS or other RS signal to be used for sensing transmission/reception. In some embodiments, the type of the sensing RS or RS includes the time duration, time-domain resource pattern, total bandwidth (“BW”), frequency domain resource pattern, or a subset of the sensing RS-defining parameters.

In some embodiments, the SL Sensing Request message includes the definition of the sensing information type needed by the requesting UE, e.g., definition of an intended material/composite estimation of an object of interest, tracking or ranging of an object of interest, detecting a potential object/blockage, estimating the velocity of an object of interest with respect to a global coordinate system, or a coordinate system known by the UE and the group of potentially participating UEs in the SL sensing. In some embodiments, the sensing information type further includes the type of the expected measurement/report from the candidate UE for sensing.

In some embodiments, the SL Sensing Request message includes an indication of the required QOS for the requested sensing information is included in the request message by UE. This may include all or any of latency, reliability/accuracy of the required sensing information, request importance/priority, security/privacy, or a combination thereof as defined within elements of sensing QoS.

This may include, but not limited to, the expected sensing time-duration, expected sensing mode by the UE including sensing Tx mode, or sensing Rx mode, or a combination thereof, the required sensing Tx node transmit power or other UE capability related elements.

In some embodiments, the SL Sensing Request message includes an indication of a time/periodicity/repetition pattern of an intended sensing task to be done by the candidate UE, time information when the sensing information is needed, the periodicity or time-interval between the two requested sensing operation, the number of the requested radar sensing operation or total time duration for which the requested sensing operation needs to be repeated.

In some embodiments, sensing request refers to a time-point in the future, e.g., the sensing operation is requested to be done after 1 second and before 2 seconds with respect to the request message time or some known time reference. In this case, the expected time-of-interest for performing the required sensing task is included in the UE request message. In some embodiments, the request includes a validity period, e.g., a time duration for which the request is still valid.

In another embodiment of the third embodiment, the SL Sensing Request message includes the definition of an area of interest and/or location of the object of interest which is intended for sensing.

In some embodiments, the SL Sensing Request message includes an indication of the object or area of interest via an object ID when the object may be previously known to the other UEs, or via location information defining the object/area of interest for sensing/monitoring or information defining the direction of interest for sensing/monitoring.

In some embodiments, the location or directional/angular information is according to a local coordinate system known to the candidate UEs, a global coordinate system, a beam identifier where the area of interest is of the same direction as a known previous transmission by that beam. In some embodiments, the object/area of interest is defined in relation to a known object by the other UEs. In one implementation, the angular direction or beam associated with the object of interest is indicated via a QCL type-D relation with a common network beam/signal or a previously transmitted UE beam/signal, where additional information defining the relative angle, relative displacement of object/area of interest in relation to the known beam.

In some embodiments, the SL Sensing Request message may include the condition that the sensing UE must enjoy a LOS condition towards the transmitting UE. In some embodiments, a configuration for the determination of the LoS condition is included in the SL Sensing Request message or has been previously configured by the network.

In some embodiments, the SL Sensing Request message includes the condition that the sensing UE must enjoy a NLoS reception on a specific beam. In some embodiments, a configuration for the determination of the NLoS condition is included in the SL Sensing Request message or has been previously configured by the network.

In a further embodiment of the third solution, in order to facilitate SL sensing with an assisting UE over a period of time, according to this embodiment, the SL Sensing Request message includes a time pattern for which the candidate UE must satisfy some stationarity conditions according to the SL Sensing Request message.

In some embodiments, the stationarity condition includes for the UE to remain at the same position, or the same velocity, or the same orientation or a combination thereof for an indicated time window. In some embodiments, the stationarity condition is defined over one or multiple specific directions for position stationarity, one or multiple specific directions for velocity stationarity, one or multiple specific direction/angle for orientation stationarity, or some combinations thereof.

In some embodiments, the stationarity condition includes one or multiple or separate thresholds to define the stationarity of location or velocity or orientation or a combination thereof along one or multiple defined directions. In some embodiments, the specific directions for position stationarity are defined within the UE local coordinate system or a known coordinated system to the UE.

In some embodiments, multiple stationarity conditions can be defined for the UE where each stationarity condition and the parameters defining the stationarity conditions may be defined separately or in relation to the other or previously defined stationary conditions. In some embodiments, a stationarity condition may be defined as the UE capability maintaining a beam towards an area/angle/angular region of interest, within a defined period of time.

In some embodiments, the stationarity condition includes a defined time window in the past where the indicated stationarity condition is tested. In some embodiments, the stationarity condition includes an indicated statistical confidence margin, e.g., to satisfy the indicated stationarity condition within the X time window into the future with Y probability.

In order to facilitate SL sensing with an assisting UE, depending on the specific sensing type and/or sensing QoS of interest, the requirements on participating UEs in SL sensing may be different. According to this embodiment of the third solution, the requirements on time synchronization and/or connected state of the candidate UEs are included in the SL radio sensing request message.

In some embodiments, as part of the SL sensing request message response and/or the measurements report for SL sensing UE/beam identification, the synchronization status of the candidate UEs for SL sensing are included in the response/report.

In some embodiments, in-coverage condition is indicated as a requirement for candidate UE for participating in SL sensing. In some embodiments, the in-coverage requirement is relaxed, but with an indication of a time-window from the latest instance of time-synchronization with the network and/or a maximum level of time-misalignment for the candidate UE for SL sensing. In some embodiments, the indication of the latest synchronization RS type and/or the reference node used for synchronization are included in the report to the requesting node for SL sensing.

In some embodiments, the in-coverage status and/or the use of a UE-based RS for synchronization is accompanied with a Cell ID in order to distinguish the nodes with non-similar network nodes as their reference point for synchronization.

In some embodiments, the method of synchronization, the used synchronization RS, as well as the time duration from the last synchronization operation or a combination thereof are used to establish the synchronization status/accuracy.

In some embodiments, an index from a codebook is indicated by the requesting UE to define the required criterion/requirement on the synchronization status for SL sensing participation, where the codebook includes different valid synchronization status for SL sensing. In some embodiments, this is determined based on the intended use-case/application of SL sensing by the requesting UE and/or the desired sensing QoS. Upon reception of the indication of the criterion/requirement on the synchronization status, in some embodiments, only the UEs which satisfy the indicated criterion will respond to the received SL sensing request message.

In some embodiments, the candidate UEs are indicated with a request to participate in a re-synchronization procedure upon participation in the sensing procedure. In some embodiments, upon identification of a UE for SL sensing participation, the identified UE will be configured with resources for synchronization by the requesting UE or by the network, depending on the in-coverage status of the identified UEs for SL sensing.

In some embodiments, when a dedicated procedure for SL synchronization for sensing is to be configured by the requesting UE for SL sensing, the requirements on the candidate UE synchronization status are relaxed or canceled.

In some embodiments, an index from a codebook is indicated by the requesting UE to define the required criterion/requirement on the synchronization status for SL sensing participation, where the codebook includes different valid synchronization status for SL sensing. In some embodiments, this is determined based on the intended use-case/application of SL sensing by the requesting UE and/or the desired sensing QoS.

In some embodiments, the synchronization priority/quality order is re-defined (different from what is specified for communications) to reflect the needs of SL sensing, e.g., the UEs with potentially lower synchronization mismatch to the requesting UE and/or other UEs as the candidate UEs for SL sensing participation will be considered with a higher priority.

In some embodiments, the need for additional synchronization procedure and/or beam refinement will be determined based on the received reports on the synchronization status. In further embodiments, the type of the measurement configuration for SL sensing beam identification will be determined based on the received reports on the synchronization status.

In some embodiments, the synchronization status is defined as an estimate of the clock mismatch between the candidate UE for SL sensing and a reference node, e.g., the network node. In some embodiments, the mismatch is defined in terms of the expected error, or error variance.

In some embodiments, the requirement to report and/or consider synchronization status as a criterion is defined via the SL sensing request message.

In some embodiments, a SL Sensing Request message for repeating a previously granted/performed sensing operation is made via a repetition indication, combined with a reference to a previously performed sensing operation. The said indicator may include an identification number for the previously performed sensing operation or referring to the n-th previously performed sensing operation. In some embodiments, a request message refers to the n-th previously sent request message, which was not necessarily granted.

In some embodiments, the request message refers to a previously performed sensing operation or a previously sent request message with some additional information for modification. In one implementation, the previously sent but not-granted request message is indicated, together with a different level of sensing QoS, e.g., a lower required range resolution. In one implementation, a previously sent request is referenced, together with an updated sensing duration.

In some embodiments, only a subset of the above information elements is included in the request message. In some embodiments, the information embedded within the SL Sensing Request message is indicated via an index from a codebook, where the codebook defines different possible values for the abovementioned information elements. In some embodiments, one or multiple codebooks for defining the sensing request information is available, where each codebook includes possible values for one or a subset of the information elements within the message. In some embodiments, codebooks defining the above information elements are defined in accordance with the envisioned use-cases that may be relevant for the UE application. In some embodiments, the information elements within the request message are assumed to hold a default value, unless the value of the information element is explicitly or implicitly defined in the request message. In some embodiments, the possible/supported codebook entries for SL Sensing Request message are transferred to the UE from the network or transferred from the requesting UE via a configuration message from the requesting UE or the initial synchronization process in the SL. In some embodiments, the transfer of the supported codebook entries for UE sensing request is transmitted by the network upon indication of the relevant UE capability or a service request.

In some embodiments, the information regarding the LoS/NLoS condition of the candidate UE, the stationarity of a candidate UE, as well as other criterion defined related to the UE suitability for participation are defined with respect to a beam indicated with a QCL type-D relation with a RS known to all of the candidate UEs, a group of candidate UEs or to a single candidate UE or a combination thereof.

In some embodiments of the third solution, in response to the reception of the SL Sensing Request message and/or, if configured, the performed measurements, a UE which satisfies the indicated conditions within the SL Sensing Request message transmits a response to the requesting UE.

In some embodiments, the response includes the indication that the UE is determined to have the sensing capability and satisfies the defined criteria. In some embodiments, the UEs not having the sensing capability do not send a response. In some embodiments, when UE capability for sensing is not determined, UE sends a response to the including the set of criteria which are not met, a measurements report when the suitability determination of the candidate UE is based on a configured measurement, a suggestion for a different sensing requirement which would be feasible with the candidate UE or a combination thereof.

In some embodiments, the information elements indicating the satisfaction of the UE capability for sensing participation is included in the response message.

In some embodiments, a report on the performed measurements and other suitability-related criterion are included in the response message, according to the received configurations for sensing measurements and the SL Sensing Request message and/or the configuration received from network, where the requesting UE makes the determination of the candidate UE suitability for sensing according to the received measurement report.

In some embodiments, when the response is transmitted over a shared SL channel among a group of candidate UEs, the response message is sent also in a group-cast manner whereby the candidate UEs also monitor the response from the other UEs. In some embodiments, upon the detection of a sufficient number of positive responses from the candidate UEs, a candidate UE terminates its measurement process for sensing suitability determination, do not send a response even if the sensing suitability criteria are satisfied.

In some embodiments, upon the reception of SL Sensing Request message response a UE or a group of UE devices are identified to participate in the SL sensing operation. In some embodiments, upon reception of the sufficient responses from the candidate UEs satisfying the needed requirements, the requesting UE sends a termination message to the group of UE candidates to indicate that no further contribution is needed.

In certain embodiments of the third solution, the SL physical channels and/or dedicated resource pools for sensing measurements/configurations are used for the transmission of SL radio sensing request message, the transmission of the configuration for SL sensing measurements for UE/beam identification for sensing, the transmission of the measurements report and/or the SL radio sensing request message response or a combination thereof.

In some implementations, the SL radio sensing request message is sent via a dedicated Sidelink Control Information (“SCI”) to single or multiple UEs, or via a broadcast message, e.g., via Physical Sidelink Broadcast Channel (“PSBCH”), or via a groupcast message, e.g., via a SCI in PSCCH with CRC scrambled with a group-common RNTI, where the group-common RNTI is shared among a previously identified group of candidate UEs for SL sensing.

In some implementations, the SL radio sensing request message response is sent via a dedicated SCI to the requesting UE, or via a broadcast message, e.g., via PSBCH, or via a groupcast message, e.g., via a SCI in PSCCH with CRC scrambled with a group-common RNTI, where the group-common RNTI is shared among a previously identified group of candidate UEs for SL sensing.

In some implementations, the configurations including the content/type of the SL radio sensing request message and/or the content/type of parts of the information elements within the SL radio sensing request message are configured by network during the connected state of the UEs and remain valid also when they are out of coverage. In this case, the singling via a SL broadcast or groupcast message or a dedicated SCI within PSCCH includes an activation of the previously configured measurement and/or additional information which together with the previously received information elements from the network constitute the information elements within the SL radio sensing request message.

An example would be when the codebooks for the possible type of the information elements, e.g., possible sensing information types and/or sensing QoS and/or stationarity conditions defined above within the SL radio sensing request message are communicated via RRC signaling and/or broadcast signaling in SIB, or dedicated or multicast signaling vias PDCCH during the connected UE state, and the codebook index defining the respective information element is transmitted via a dedicated or common SCI or broadcast SL message or a combination thereof.

In some implementations, when a requesting UE is in the connected state, a SL radio sensing request message is sent to the network. In response, the network configures a sensing scenario and/or dynamically configures resources for transmission of the SL radio sensing request message in SL to facilitate identification of the SL UE for sensing participation among the other UEs which are also in the connected state. In some embodiments, when the requesting UE for SL sensing or sensing is in connected mode and the SL sensing scenario is to be established among the UEs in the connected mode, the SL radio sensing request message and other messages transmitted via the requesting UE, the SL radio sensing request message response or some combinations thereof are transmitted via PUCCH as an UCI or via PUSCH. In some embodiments, the signaling from the network to the UE nodes in the connected mode participating in the SL sensing UE identification are done via a dedicated or a group-common DCI or via RRC signaling or a combination thereof.

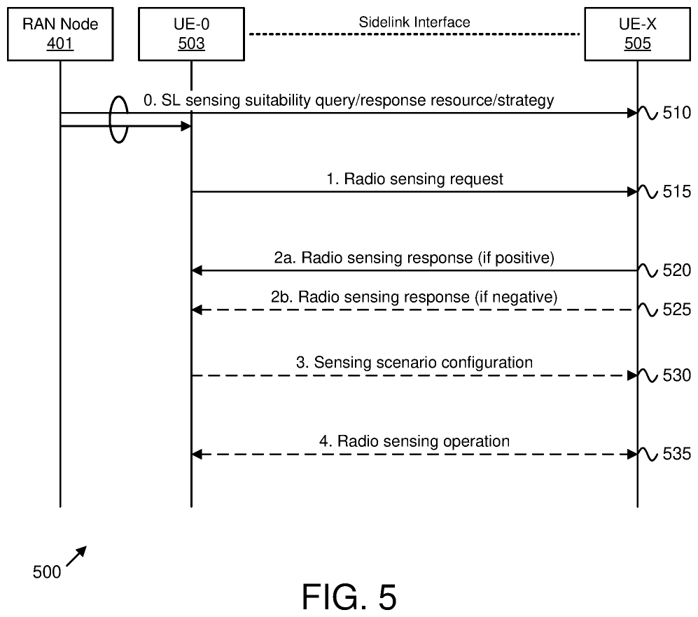

FIG. 5 depicts an exemplary message sequence 500 between a requesting UE (i.e., UE-0 503) for SL sensing and the other candidate UEs (i.e., UE-X 505). The dashed lines are messages which may be transmitted in the process for the proper UE/beam identification, whereas the solid lines are the messages which are necessary for establishing the SL sensing scenario.

At Step 0, the RAN node 401 sends a configuration to the UEs 503, 505 including one or more of resources for the SL sensing suitability query transmission, resources for the SL sensing suitability query reception, resources for the SL sensing suitability query response transmission, resources for the SL sensing suitability query response reception, strategy for suitability determination for participation in a radio sensing operation, type of the response to be transmitted based on the received SL sensing suitability query and the suitability determination (see messaging 510).

At Step 1, the UE-0 503 sends a sensing suitability query message to the UE-X 505 (see messaging 515). Here, the contents of the sensing suitability query may be as described herein.

At Step 2, the UE-X 505 evaluates one or more suitability criteria (also referred to herein as “suitability conditions”) and determines which criteria are met by the UE-X 505. Based on which criteria are met, the UE-X 505 may send a positive response to the UE-0 503 or may send a negative response to the UE-0 503.

At Step 2a, the UE-X 505 sends a positive Query Response message to the 401 (see messaging 520). In certain embodiments, the response includes the indication that the UE is determined to have the sensing capability and satisfies at least a minimum subset of the defined suitability criteria. In some embodiments, the response indicates that the UE satisfies all the defined suitability criteria. In other embodiments, the response indicates that the UE satisfies only a subset of the defined suitability criteria.

At optional Step 2b, the UE-X 505 sends a negative Query Response to the UE-0 503 (see messaging 525). In certain embodiments, the UE 405 may send a response to the network including the set of criteria which are not met. In other embodiments, the UEs not having the sensing capability, or not satisfying a minimum subset of the suitability criteria, do not send a report to the network.

At optional Step 3, the RAN node 401 may optionally send a sensing scenario configuration (also referred to as a configuration for participating in a radio sensing operation) to the UE-X 505 (see messaging 530). Here, the sensing scenario configuration may include one or more of: a configuration for radio sensing RS transmission, a configuration for radio sensing RS reception, and a configuration for radio sensing measurement report transmission.

At Step 4, the UE-0 503 and the UE-X 505 may participate in the radio sensing operation, e.g., based on the configuration exchanged in step 3 (see messaging 535). For example, the UE-0 503 may transmit a sensing RS and the UE-X 505 may receive/measure the sensing RS and send a measurement report to the UE-0 503. In the depicted embodiment, it is assumed that the UE-X 505 meets at least a minimum subset of the suitability criteria and is thus selected to participate in the radio sensing operation. The message sequence 500 ends.

In some embodiments, dedicated SL resource pools are configured for SL message exchange for sensing configuration and/or sensing measurements.

In some implementations, information elements for part of the SL radio sensing request message are sent separately from another part, e.g., sent via a separate resource and/or signaling mechanism. In some embodiments, information elements for part of the SL radio sensing request message response are sent separately from another part, e.g., sent via a separate resource and/or signaling mechanism.

In some implementations, when the requesting UE is not connected to the network, but one of a receiving UE is in the connected mode, the connected UE sends a report to the network on the received request and the expected resource occupancy and the expected sensing task. In response, the network may send a configuration message including a collision indication to prevent the expected sensing operation. In another embodiment, the network response may include suggested resources for sensing configuration. In some embodiments, a report from the performed sensing measurements and the configured sensing resources are sent to the network by the connected UEs.

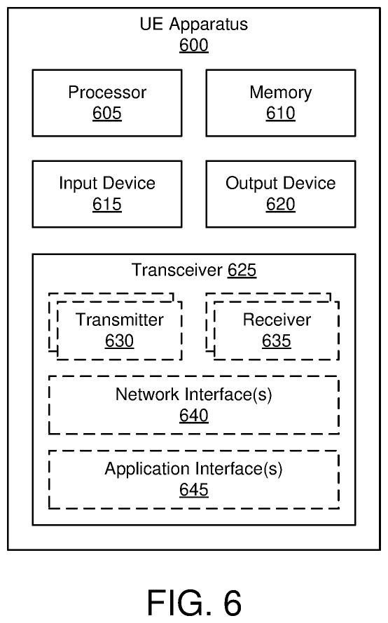

FIG. 6 illustrates an example of a UE apparatus 600 that may be used for configuring participation in a radio sensing operation, in accordance with aspects of the present disclosure. In various embodiments, the UE apparatus 600 is used to implement one or more of the solutions described above. The UE apparatus 600 may be an example of a user endpoint, such as the remote unit 105 and/or the UE 205, as described above. Furthermore, the UE apparatus 600 may include a processor 605, a memory 610, an input device 615, an output device 620, and a transceiver 625.

In some embodiments, the input device 615 and the output device 620 are combined into a single device, such as a touchscreen. In certain embodiments, the UE apparatus 600 may not include any input device 615 and/or output device 620. In various embodiments, the UE apparatus 600 may include one or more of: the processor 605, the memory 610, and the transceiver 625, and may not include the input device 615 and/or the output device 620.

As depicted, the transceiver 625 includes at least one transmitter 630 and at least one receiver 635. In some embodiments, the transceiver 625 communicates with one or more cells (or wireless coverage areas) supported by one or more base station units 121. In various embodiments, the transceiver 625 is operable on unlicensed radio spectrum (also referred to as “shared spectrum”). Moreover, the transceiver 625 may include multiple UE panels supporting one or more beams. Additionally, the transceiver 625 may support at least one network interface 640 and/or application interface 645. The application interface(s) 645 may support one or more APIs. The network interface(s) 640 may support 3GPP reference points, such as Uu, N1, PC5, etc. Other network interfaces 640 may be supported, as understood by one of ordinary skill in the art.

The processor 605, in one embodiment, may include any known controller capable of executing computer-readable instructions and/or capable of performing logical operations. For example, the processor 605 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 605 executes instructions stored in the memory 610 to perform the methods and routines described herein. The processor 605 is communicatively coupled to the memory 610, the input device 615, the output device 620, and the transceiver 625.

In various embodiments, the processor 605 controls the UE apparatus 600 to implement the above-described UE behaviors. In certain embodiments, the processor 605 may include an application processor (also known as “main processor”) which manages application-domain and operating system (“OS”) functions and a baseband processor (also known as “baseband radio processor”) which manages radio functions.

In various embodiments, via the transceiver 625, the processor 605 receives, from a network node, a query message (e.g., a sensing suitability query) for radio sensing participation, where the query message indicates a set of suitability conditions. The processor 605 determines whether the UE apparatus 600 satisfies the set of suitability conditions. Via the transceiver 625, the processor 605 transmits, to the network node, a response message (e.g., a suitability report) based on the determination and receives a sensing configuration for participating in a radio sensing operation in response to sending the response message. The processor 605 performs the radio sensing operation according to the sensing configuration. Here, the sensing configuration includes a configuration for radio sensing RS transmission, a configuration for radio sensing RS reception, and/or a configuration for radio sensing measurement report transmission.

In some embodiments, the set of suitability conditions may include: A) an indication of an object (or target) of interest to be monitored via radio sensing; B) an indication of an area of interest to be monitored via radio sensing; C) an indication of an angle (or sector or angular region) of interest to be monitored via radio sensing; D) a type of radio sensing task; or E) combinations thereof.

In certain embodiments, the indication of the object (or target) of interest includes one or more of: A) a target location (e.g., defined using a coordinate system known to the UE apparatus 600); B) a target boundary location (e.g., potential object/target location defined according to a coordinate system known to the UE apparatus 600); C) a definition of the target of interest according to a QCL type-D assumption (e.g., with respect to a signal known to the UE apparatus 600); D) an object identifier number (e.g., when the object/target is already known to the UE apparatus 600); E) an area of interest defined using angular and/or directional information (e.g., according to a coordinate system known to the UE apparatus 600); F) an area of interest defined using a QCL type-D assumption (e.g., with respect to a signal known to the UE apparatus 600); G) an area identifier number of an area of interest associated with the object/target (e.g., when the area of interest is already known to the UE apparatus 600); or H) combinations thereof.

In some embodiments, the query message includes a sensing suitability query, and the response message includes a suitability report (e.g., a radio sensing scenario suitability report). In such embodiments, the processor 605 may control the transceiver 625 to receive a reporting configuration for the suitability report from the network node, where the reporting configuration may include: A) a set of time-frequency resources to use to transmit the suitability report; B) a set of beams to use to transmit the suitability report; C) a type of report to be transmitted based on the set of suitability conditions; or D) combinations thereof.

In certain embodiments, the set of suitability conditions (e.g., for radio sensing participation) includes at least one of: A) a position stationarity condition of the UE apparatus 600 over an indicated time duration; B) a velocity stationarity condition of the UE apparatus 600 over the indicated time duration; C) an orientation stationarity condition of the UE apparatus 600 over the indicated time duration; D) a minimum synchronization accuracy; E) an observability condition of an area of interest; F) an observability condition of an object of interest; G) a minimum storage capability for radio sensing measurements; H) a minimum processing capability for radio sensing measurements; I) a minimum energy storage for radio sensing measurements; or J) combinations thereof.

In one embodiment, the object and/or area of interest observability is determined based on an evaluation of a LOS reception from a beam identified with a QCL type-D assumption with respect to a signal known to the UE apparatus 600. In another embodiment, the object and/or area of interest observability is determined based on an evaluation of a NLoS reception from the beam identified with the QCL type-D assumption. In certain embodiments, the set of suitability conditions (e.g., for radio sensing participation) includes an indication of a QCL type-D assumption with respect to a signal known to the UE apparatus 600.

In certain embodiments, the set of suitability conditions (e.g., for radio sensing participation) is indicated via an index from a codebook, where the codebook includes different combinations of one or more criteria for evaluating a suitability of the radio sensing scenario. In certain embodiments, the suitability report indicates which ones of the set of suitability conditions are satisfied. In certain embodiments, transmitting the suitability report occurs in response to determining that at least an indicated subset of the set of suitability conditions is met.

In some embodiments, the network node comprises a RAN node, where the query message includes a sensing suitability query. In some embodiments, the network node comprises a peer UE, where the query message includes a SL sensing request. In certain embodiments, the response message includes a suitability report (e.g., a radio sensing scenario suitability report). In such embodiments, via the transceiver 625, the processor 605 further: receives a first configuration for the suitability report from the peer UE, receives a second configuration for the suitability report from the RAN node, and/or transmits a suitability report to a RAN node.

In certain embodiments, the suitability report transmitted to the peer UE and the suitability report transmitted to the RAN node are based on the first configuration for the suitability report received from the peer UE and/or the second configuration for the suitability report received from the RAN node. In other words, the suitability report may be jointly sent to the peer UE and the RAN node, where the suitability report also may be based jointly on the configurations received from the peer UE and from the RAN node.

In certain embodiments, the first configuration for the suitability report received from the peer UE may include: A) a set of time/frequency/beam resources for transmitting the suitability report to the RAN node from the UE apparatus 600; B) a set of time/frequency/beam resources for transmitting the suitability report to the peer UE from the UE apparatus 600; C) a reporting type for the suitability report to be sent to the peer UE; D) a reporting type for the suitability report to be sent to the RAN node; E) a reporting condition (e.g., RAN reporting criteria) for the suitability report to be sent to the RAN node; F) a reporting condition (e.g., SL reporting criteria) for the suitability report to be sent to the peer UE; or G) combinations thereof. In one embodiment, the first configuration may also include a set of time/frequency/beam resources for reception of the configuration for the radio sensing operation from the RAN node.

In certain embodiments, the second configuration for the suitability report received from the RAN node may include: A) a set of time/frequency/beam resources for reception of the configuration for the radio sensing operation from the peer UE; B) a set of time/frequency/beam resources for transmitting the report to the peer UE from the UE apparatus 600; C) a set of time/frequency/beam resources for transmitting a report to the RAN node from the UE apparatus 600; D) a reporting type for the suitability report to be sent to the peer UE (e.g., based on the evaluated suitability conditions); E) a reporting type for the suitability report to be sent to the RAN node (e.g., based on the evaluated suitability conditions); F) a reporting condition (e.g., SL reporting criteria) for the suitability report to be sent to the peer UE; G) a reporting condition (e.g., RAN reporting criteria) for the suitability report to be sent to the RAN node; or H) combinations thereof.

The memory 610, in one embodiment, is a computer readable storage medium. In some embodiments, the memory 610 includes volatile computer storage media. For example, the memory 610 may include a RAM, including dynamic RAM (“DRAM”), synchronous dynamic RAM (“SDRAM”), and/or static RAM (“SRAM”). In some embodiments, the memory 610 includes non-volatile computer storage media. For example, the memory 610 may include a hard disk drive, a flash memory, or any other suitable non-volatile computer storage device. In some embodiments, the memory 610 includes both volatile and non-volatile computer storage media.

In some embodiments, the memory 610 stores data related to techniques for configuring participation in a radio sensing operation. For example, the memory 610 may store various parameters, panel/beam configurations, resource assignments, policies, and the like as described above. In certain embodiments, the memory 610 also stores program code and related data, such as an operating system or other controller algorithms operating on the UE apparatus 600.

The input device 615, in one embodiment, may include any known computer input device including a touch panel, a button, a keyboard, a stylus, a microphone, or the like. In some embodiments, the input device 615 may be integrated with the output device 620, for example, as a touchscreen or similar touch-sensitive display. In some embodiments, the input device 615 includes a touchscreen such that text may be input using a virtual keyboard displayed on the touchscreen and/or by handwriting on the touchscreen. In some embodiments, the input device 615 includes two or more different devices, such as a keyboard and a touch panel.

The output device 620, in one embodiment, is designed to output visual, audible, and/or haptic signals. In some embodiments, the output device 620 includes an electronically controllable display or display device capable of outputting visual data to a user. For example, the output device 620 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 620 may include a wearable display separate from, but communicatively coupled to, the rest of the UE apparatus 600, such as a smart watch, smart glasses, a heads-up display, or the like. Further, the output device 620 may be a component of a smart phone, a personal digital assistant, a television, a table computer, a notebook (laptop) computer, a personal computer, a vehicle dashboard, or the like.

In certain embodiments, the output device 620 includes one or more speakers for producing sound. For example, the output device 620 may produce an audible alert or notification (e.g., a beep or chime). In some embodiments, the output device 620 includes one or more haptic devices for producing vibrations, motion, or other haptic feedback. In some embodiments, all or portions of the output device 620 may be integrated with the input device 615. For example, the input device 615 and output device 620 may form a touchscreen or similar touch-sensitive display. In other embodiments, the output device 620 may be located near the input device 615.

The transceiver 625 communicates with one or more network functions of a mobile communication network via one or more access networks. The transceiver 625 operates under the control of the processor 605 to transmit messages, data, and other signals and also to receive messages, data, and other signals. For example, the processor 605 may selectively activate the transceiver 625 (or portions thereof) at particular times in order to send and receive messages.

The transceiver 625 includes at least one transmitter 630 and at least one receiver 635. One or more transmitters 630 may be used to provide UL communication signals to a base station unit 121, such as the UL transmissions described herein. Similarly, one or more receivers 635 may be used to receive DL communication signals from the base station unit 121, as described herein. Although only one transmitter 630 and one receiver 635 are illustrated, the UE apparatus 600 may have any suitable number of transmitters 630 and receivers 635. Further, the transmitter(s) 630 and the receiver(s) 635 may be any suitable type of transmitters and receivers. In one embodiment, the transceiver 625 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example, a single chip performing functions for use with both licensed and unlicensed radio spectrum. In some embodiments, the first transmitter/receiver pair and the second transmitter/receiver pair may share one or more hardware components. For example, certain transceivers 625, transmitters 630, and receivers 635 may be implemented as physically separate components that access a shared hardware resource and/or software resource, such as for example, the network interface 640.

In various embodiments, one or more transmitters 630 and/or one or more receivers 635 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 630 and/or one or more receivers 635 may be implemented and/or integrated into a multi-chip module. In some embodiments, other components such as the network interface 640 or other hardware components/circuits may be integrated with any number of transmitters 630 and/or receivers 635 into a single chip. In such embodiment, the transmitters 630 and receivers 635 may be logically configured as a transceiver 625 that uses one or more common control signals or as modular transmitters 630 and receivers 635 implemented in the same hardware chip or in a multi-chip module.

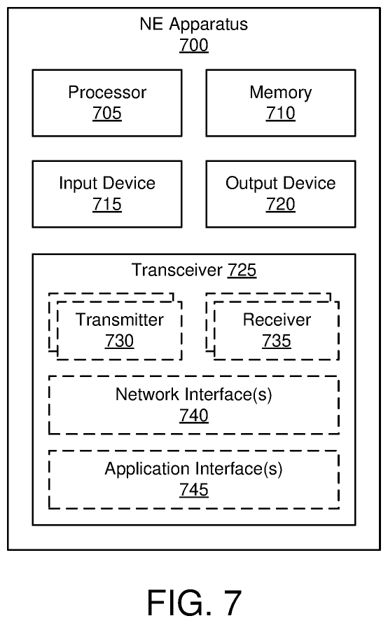

FIG. 7 illustrates an example of a NE apparatus 700 that may be used for configuring participation in a radio sensing operation, in accordance with aspects of the present disclosure. In one embodiment, the NE apparatus 700 may be one implementation of a network endpoint, such as the base station unit 121 and/or RAN node 210, as described above. Furthermore, the NE apparatus 700 may include a processor 705, a memory 710, an input device 715, an output device 720, and a transceiver 725.

In some embodiments, the input device 715 and the output device 720 are combined into a single device, such as a touchscreen. In certain embodiments, the NE apparatus 700 may not include any input device 715 and/or output device 720. In various embodiments, the NE apparatus 700 may include one or more of: the processor 705, the memory 710, and the transceiver 725, and may not include the input device 715 and/or the output device 720.

As depicted, the transceiver 725 includes at least one transmitter 730 and at least one receiver 735. Here, the transceiver 725 communicates with one or more remote units 105. Additionally, the transceiver 725 may support at least one network interface 740 and/or application interface 745. The application interface(s) 745 may support one or more APIs. The network interface(s) 740 may support 3GPP reference points, such as Uu, N1, N2 and N3. Other network interfaces 740 may be supported, as understood by one of ordinary skill in the art.

The processor 705, in one embodiment, may include any known controller capable of executing computer-readable instructions and/or capable of performing logical operations. For example, the processor 705 may be a microcontroller, a microprocessor, a CPU, a GPU, an auxiliary processing unit, a FPGA, or similar programmable controller. In some embodiments, the processor 705 executes instructions stored in the memory 710 to perform the methods and routines described herein. The processor 705 is communicatively coupled to the memory 710, the input device 715, the output device 720, and the transceiver 725.

In various embodiments, the NE apparatus 700 is a radio access entity (e.g., gNB) that communicates with one or more UEs and one or more NFs, as described herein. In such embodiments, the processor 705 controls the NE apparatus 700 to perform the above-described RAN behaviors. When operating as a radio access entity, the processor 705 may include an application processor (also known as “main processor”) which manages application-domain and operating system (“OS”) functions and a baseband processor (also known as “baseband radio processor”) which manages radio functions.

In various embodiments, via the transceiver 725, the processor 705 transmits, to a plurality of candidate devices, a query message (e.g., a sensing suitability query) for a radio sensing operation, where the query message indicates a set of suitability conditions, and receives at least one response message from at least one of the plurality of candidate devices, each response message indicating a suitability of a particular candidate device for participation in the radio sensing operation. The processor 705 determines, based on the at least one response message, a set of (i.e., one or more) devices to participate in the radio sensing operation. Via the transceiver 725, the processor 705 configures the set of devices to participate in the radio sensing operation and performs the radio sensing operation.

In some embodiments, configuring the set of devices includes transmitting a configuration for the radio sensing operation. In such embodiments, the transmitted configuration may include: A) an indication of an object (or target) of interest to be monitored via radio sensing; B) an indication of an area of interest to be monitored via radio sensing; C) an indication of an angle (or angular region) of interest to be monitored via radio sensing; D) a type of radio sensing task; or E) combinations thereof.

In certain embodiments, the indication of the object (or target) of interest includes one or more of: A) a target location (e.g., defined using a coordinate system known to a respective candidate device); B) a target boundary location (e.g., potential object/target location defined according to a coordinate system known to the respective candidate device); C) a definition of the target of interest according to a QCL type-D assumption (e.g., with respect to a signal known to the respective candidate device); D) an object identifier number (e.g., when the object/target is already known to the respective candidate device); E) an area of interest defined using angular and/or directional information (e.g., according to a coordinate system known to the respective candidate device); F) an area of interest defined using a QCL type-D assumption (e.g., with respect to a signal known to the respective candidate device); G) an area identifier number of an area of interest associated with the object/target (e.g., when the area of interest is already known to the respective candidate device); or H) combinations thereof.

In some embodiments, the query message includes a sensing suitability query, and the response message includes a suitability report (e.g., a radio sensing scenario suitability report). In such embodiments, the processor 705 may transmit, via the transceiver 725, a configuration for the suitability report to the candidate devices, where the configuration for the suitability report may include: A) a set of time-frequency resources to use to transmit the suitability report; B) a set of beams to use to transmit the suitability report; C) a type of report to be transmitted based on the set of suitability conditions; or D) combinations thereof.

In certain embodiments, the set of suitability conditions (e.g., for radio sensing participation) includes at least one of: A) a position stationarity condition of a respective candidate device over an indicated time duration; B) a velocity stationarity condition of the respective candidate device over the indicated time duration; C) an orientation stationarity condition of the respective candidate device over the indicated time duration; D) a minimum synchronization accuracy; E) an observability condition of an area of interest; F) an observability condition of an object of interest; G) a minimum storage capability for radio sensing measurements; H) a minimum processing capability for radio sensing measurements; I) a minimum energy storage for radio sensing measurements; or J) combinations thereof.

In one embodiment, the object and/or area of interest observability is determined based on an evaluation of a LoS reception from a beam identified with a QCL type-D assumption with respect to a signal known to a respective candidate device. In another embodiment, the object and/or area of interest observability is determined based on an evaluation of a NLoS reception from the beam identified with the QCL type-D assumption. In certain embodiments, the set of suitability conditions (e.g., for radio sensing participation) includes an indication of a QCL type-D assumption with respect to a signal known to the respective candidate device.

In certain embodiments, the set of suitability conditions (e.g., for radio sensing participation) is indicated via an index from a codebook, where the codebook includes different combinations of one or more criteria for evaluating a suitability of the radio sensing scenario. In certain embodiments, the suitability report indicates which ones of the set of suitability conditions are satisfied. In certain embodiments, the processor 705 may indicate a subset of the set of suitability conditions for triggering the suitability report. Here, the particular candidate device sends the suitability report when it meets at least the indicated subset of the set of suitability conditions.

In some embodiments, the network node comprises a RAN node, wherein the query message includes a sensing suitability query. In certain embodiments, the processor 705 may transmit, via the transceiver 725, a configuration for the suitability report to a respective candidate device, where the transmitted configuration for the suitability report may include: A) a set of time/frequency/beam resources for reception of a configuration for the radio sensing operation from the RAN node; B) a set of time/frequency/beam resources for reception of a configuration for the radio sensing operation from a peer UE; C) a set of time/frequency/beam resources for transmitting the suitability report to the RAN node from the respective candidate device; D) a set of time/frequency/beam resources for transmitting the suitability report to a peer UE from the respective candidate device; E) a reporting type for the suitability report to be sent to the peer UE (e.g., based on the evaluated suitability conditions); F) a reporting type for the suitability report to be sent to the RAN node (e.g., based on the evaluated suitability conditions); G) a reporting condition (e.g., RAN reporting criteria) for the suitability report to be sent to the RAN node; H) a reporting condition (e.g., SL reporting criteria) for the suitability report to be sent to the peer UE; or I) combinations thereof.

In some embodiments, the network node comprises a peer UE, where the query message includes a SL sensing request. In certain embodiments, the processor 705 may transmit, via the transceiver 725, a configuration to a respective candidate device, where the transmitted configuration may include: A) a set of time/frequency/beam resources for transmitting the suitability report to a RAN node from the respective candidate device; B) a set of time/frequency/beam resources for transmitting the suitability report to the peer UE from the respective candidate device; C) a reporting type for the suitability report to be sent to the peer UE (e.g., based on the evaluated suitability conditions); D) a reporting type for the suitability report to be sent to the RAN node (e.g., based on the evaluated suitability conditions); E) a reporting condition (e.g., RAN reporting criteria) for the suitability report to be sent to the RAN node; F) a reporting condition (e.g., SL reporting criteria) for the suitability report to be sent to the peer UE; or G) combinations thereof.

The memory 710, in one embodiment, is a computer readable storage medium. In some embodiments, the memory 710 includes volatile computer storage media. For example, the memory 710 may include a RAM, including dynamic RAM (“DRAM”), synchronous dynamic RAM (“SDRAM”), and/or static RAM (“SRAM”). In some embodiments, the memory 710 includes non-volatile computer storage media. For example, the memory 710 may include a hard disk drive, a flash memory, or any other suitable non-volatile computer storage device. In some embodiments, the memory 710 includes both volatile and non-volatile computer storage media.

In some embodiments, the memory 710 stores data related to techniques for configuring participation in a radio sensing operation. For example, the memory 710 may store parameters, configurations, resource assignments, policies, and the like, as described above. In certain embodiments, the memory 710 also stores program code and related data, such as an operating system or other controller algorithms operating on the NE apparatus 700.

The input device 715, in one embodiment, may include any known computer input device including a touch panel, a button, a keyboard, a stylus, a microphone, or the like. In some embodiments, the input device 715 may be integrated with the output device 720, for example, as a touchscreen or similar touch-sensitive display. In some embodiments, the input device 715 includes a touchscreen such that text may be input using a virtual keyboard displayed on the touchscreen and/or by handwriting on the touchscreen. In some embodiments, the input device 715 includes two or more different devices, such as a keyboard and a touch panel.

The output device 720, in one embodiment, is designed to output visual, audible, and/or haptic signals. In some embodiments, the output device 720 includes an electronically controllable display or display device capable of outputting visual data to a user. For example, the output device 720 may include, but is not limited to, an LCD display, an LED display, an OLED display, a projector, or similar display device capable of outputting images, text, or the like to a user. As another, non-limiting, example, the output device 720 may include a wearable display separate from, but communicatively coupled to, the rest of the NE apparatus 700, such as a smart watch, smart glasses, a heads-up display, or the like. Further, the output device 720 may be a component of a smart phone, a personal digital assistant, a television, a table computer, a notebook (laptop) computer, a personal computer, a vehicle dashboard, or the like.

In certain embodiments, the output device 720 includes one or more speakers for producing sound. For example, the output device 720 may produce an audible alert or notification (e.g., a beep or chime). In some embodiments, the output device 720 includes one or more haptic devices for producing vibrations, motion, or other haptic feedback. In some embodiments, all or portions of the output device 720 may be integrated with the input device 715. For example, the input device 715 and output device 720 may form a touchscreen or similar touch-sensitive display. In other embodiments, the output device 720 may be located near the input device 715.

The transceiver 725 includes at least one transmitter 730 and at least one receiver 735. One or more transmitters 730 may be used to communicate with the UE 205, as described herein. Similarly, one or more receivers 735 may be used to communicate with network functions in the PLMN and/or RAN, as described herein. Although only one transmitter 730 and one receiver 735 are illustrated, the NE apparatus 700 may have any suitable number of transmitters 730 and receivers 735. Further, the transmitter(s) 730 and the receiver(s) 735 may be any suitable type of transmitters and receivers.

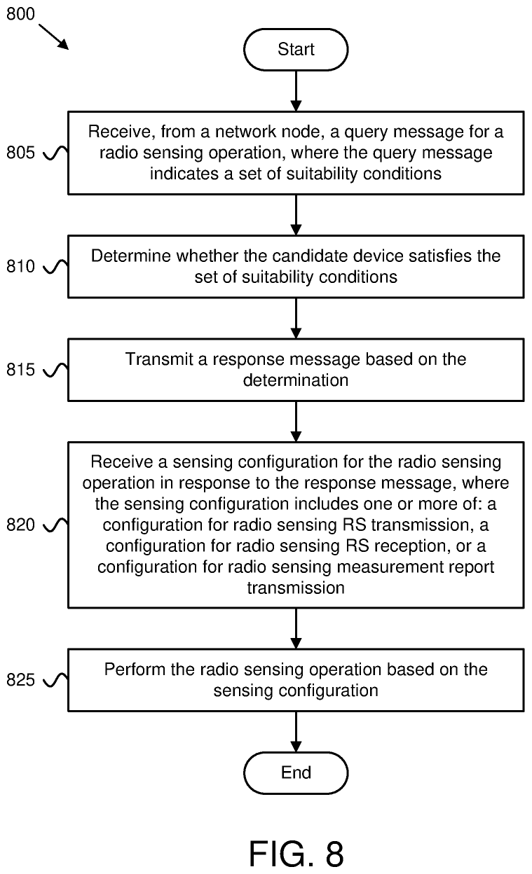

FIG. 8 illustrates a flowchart of a method 800 for configuring participation in a radio sensing operation, in accordance with aspects of the present disclosure. The operations of the method 800 may be implemented by a candidate device, such as the remote unit 105, the UE 205, the first UE 305, the second UE 307, the UE 405, the UE-0 503, the UE-X 505, and/or the UE apparatus 600 (or components thereof), as described herein. Additionally, or alternatively, the operations of the method 800 may be performed by a processor executing program code, for example, a microcontroller, a microprocessor, a CPU, a GPU, an auxiliary processing unit, a FPGA, or the like.

The method 800 includes receiving 805, from a network node, a query message (e.g., a sensing suitability query) for a radio sensing operation, wherein the query message indicates a set of suitability conditions. The method 800 includes determining 810 whether the candidate device satisfies the set of suitability conditions. The method 800 includes transmitting 815, to the network node, a response message (e.g., a suitability report) based on the determination. The method 800 includes receiving 820 a sensing configuration for the radio sensing operation, in response to the response message. Here, the sensing configuration includes a configuration for radio sensing RS transmission, a configuration for radio sensing RS reception, and/or a configuration for radio sensing measurement report transmission. The method 800 includes performing 825 the radio sensing operation based on the sensing configuration. The method 800 ends.

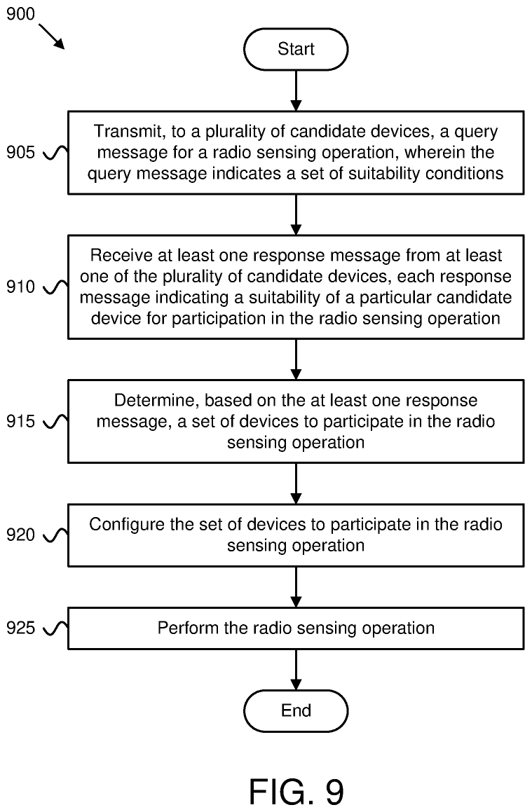

FIG. 9 illustrates a flowchart of a method 900 for configuring participation in a radio sensing operation, in accordance with aspects of the present disclosure. The operations of the method 900 may be implemented by a transmitting entity, such as remote unit 105, the base station unit 121, the UE 205, the RAN node 210, the first RAN entity 301, the second RAN entity 303, the first UE 305, the RAN node 401, the UE-0 503, the UE apparatus 600, and/or the NE apparatus 700 (or components thereof), as described herein. Additionally, or alternatively, the operations of the method 900 may be performed by a processor executing program code, for example, a microcontroller, a microprocessor, a CPU, a GPU, an auxiliary processing unit, a FPGA, or the like.

The method 900 includes transmitting 905, to a plurality of candidate devices, a query message (e.g., a sensing suitability query) for a radio sensing operation, wherein the query message indicates a set of suitability conditions. The method 900 includes receiving 910 at least one response message from at least one of the plurality of candidate devices, each response message indicating a suitability of a particular candidate device for participation in the radio sensing operation. The method 900 includes determining 915, based on the at least one response message, a set of devices to participate in the radio sensing operation. The method 900 includes configuring 920 the set of devices to participate in the radio sensing operation. The method 900 includes performing 925 the radio sensing operation. The method 900 ends.

Disclosed herein is a first apparatus for identifying UEs to participate in a radio sensing operation, according to embodiments of the disclosure. The first apparatus may be implemented by a candidate device, such as the remote unit 105, the UE 205, the first UE 305, the second UE 307, the UE 405, the UE-X 505, and/or the UE apparatus 600, described above. The first apparatus includes a memory coupled to a processor, the memory storing instructions executable by the processor to cause the first apparatus to: A) receive, from a network node, a query message (e.g., a sensing suitability query) for radio sensing operation, where the query message indicates a set of suitability conditions; B) determine whether the first apparatus satisfies the set of suitability conditions; C) transmit, to the network node, a response message (e.g., a suitability report) based on the determination; D) receive a sensing configuration for the radio sensing operation in response to the response message; and E) perform the radio sensing operation based on the sensing configuration. Here, the sensing configuration may include a configuration for radio sensing RS transmission, a configuration for radio sensing RS reception, and/or a configuration for radio sensing measurement report transmission.

In some embodiments, the set of suitability conditions may include: A) an indication of an object (or target) of interest to be monitored via radio sensing; B) an indication of an area of interest to be monitored via radio sensing; C) an indication of an angle (or angular region or sector) of interest to be monitored via radio sensing; D) a type of radio sensing task; or E) combinations thereof.

In certain embodiments, the indication of the object (or target) of interest includes one or more of: A) a target location (e.g., defined using a coordinate system known to the first apparatus); B) a target boundary location (e.g., potential object/target location defined according to a coordinate system known to the first apparatus); C) a definition of the target of interest according to a QCL type-D assumption (e.g., with respect to a signal known to the first apparatus); D) an object identifier number (e.g., when the object/target is already known to the first apparatus); E) an area of interest defined using angular and/or directional information (e.g., according to a coordinate system known to the first apparatus); F) an area of interest defined using a QCL type-D assumption (e.g., with respect to a signal known to the first apparatus); G) an area identifier number of an area of interest associated with the object/target (e.g., when the area of interest is already known to the first apparatus); or H) combinations thereof.

In some embodiments, the query message includes a sensing suitability query, and the response message includes a suitability report (e.g., a radio sensing scenario suitability report). In such embodiments, the instructions are executable by the processor to cause the first apparatus to receive, from the network node, a reporting configuration for the suitability report, where the configuration for the suitability report may include: A) a set of time-frequency resources to use to transmit the suitability report; B) a set of beams to use to transmit the suitability report; C) a type of report for the suitability report based on the set of suitability conditions; or D) combinations thereof.

In certain embodiments, the set of suitability conditions includes at least one of: A) a position stationarity condition of the first apparatus over an indicated time duration; B) a velocity stationarity condition of the first apparatus over the indicated time duration; C) an orientation stationarity condition of the first apparatus over the indicated time duration; D) a minimum synchronization accuracy; E) an observability condition of an area of interest; F) an observability condition of an object of interest; G) a minimum storage capability for radio sensing measurements; H) a minimum processing capability for radio sensing measurements; I) a minimum energy storage for radio sensing measurements; or J) combinations thereof.

In one embodiment, the object and/or area of interest observability is determined based on an evaluation of a LOS reception from a beam identified with a QCL type-D assumption with respect to a signal known to the first apparatus. In another embodiment, the object and/or area of interest observability is determined based on an evaluation of a NLoS reception from the beam identified with the QCL type-D assumption. In certain embodiments, the set of suitability conditions includes an indication of a QCL type-D assumption with respect to a signal known to the first apparatus.

In certain embodiments, the set of suitability conditions is indicated via an index from a codebook, where the codebook includes different combinations of one or more criteria for evaluating a suitability of the radio sensing scenario. In certain embodiments, the suitability report indicates one or more suitability conditions of the set of suitability conditions which are satisfied by the first apparatus. In certain embodiments, the instructions are executable by the processor to cause the apparatus to transmit the suitability report based on a determination that at least an indicated subset of the set of suitability conditions is met.

In some embodiments, the network node comprises a RAN node, where the query message includes a sensing suitability query. In some embodiments, the network node comprises a peer UE, where the query message includes a SL sensing request. In certain embodiments, the response message includes a suitability report (e.g., a radio sensing scenario suitability report). In such embodiments, the instructions are executable by the processor to cause the first apparatus to: receive a first reporting configuration for the suitability report from the peer UE, receive a second reporting configuration for the suitability report from the RAN node, and/or transmit the suitability report to the RAN node.

In certain embodiments, the suitability report is based on the first reporting configuration, where the first reporting configuration may include: A) a first set of time/frequency/beam resources for transmitting the suitability report to the RAN node; B) a second set of time/frequency/beam resources for transmitting the suitability report to the peer UE; C) a first reporting type associated with the peer UE; D) a second reporting type associated with the RAN node; E) a first reporting condition (e.g., one or more RAN reporting criteria) associated with the RAN node; F) a second reporting condition (e.g., one or more SL reporting criteria) associated with the peer UE; or G) combinations thereof.

In certain embodiments, the suitability report is based on the second reporting configuration, where the second configuration for the suitability report received from the RAN node may include: A) a first set of time/frequency/beam resources for reception of the query message from the peer UE; B) a second set of time/frequency/beam resources for transmitting a report to the peer UE; C) a third set of time/frequency/beam resources for transmitting a report to the RAN node; D) a first reporting type associated with the peer UE (e.g., based on the evaluated suitability conditions); E) a second reporting type associated with the RAN node (e.g., based on the evaluated suitability conditions); F) a first reporting condition (e.g., one or more SL reporting criteria) associated with the peer UE; G) a second reporting condition (e.g., one or more RAN reporting criteria) associated with the RAN node; or H) combinations thereof.

Disclosed herein is a first method for identifying UEs to participate in a radio sensing operation, according to embodiments of the disclosure. The first method may be performed by a candidate device, such as the remote unit 105, the UE 205, the first UE 305, the second UE 307, the UE 405, the UE-X 505, and/or the UE apparatus 600, described above. The first method includes receiving, from a network node, a query message (e.g., a sensing suitability query) for a radio sensing operation, where the query message indicates a set of suitability conditions. The first method includes determining whether the candidate device satisfies the set of suitability conditions and transmitting, to the network node, a response message (e.g., a suitability report). The first method includes receiving a sensing configuration for the radio sensing operation in response to the response message and performing the radio sensing operation based on the sensing configuration. Here, the sensing configuration may include a configuration for radio sensing RS transmission, a configuration for radio sensing RS reception, and/or a configuration for radio sensing measurement report transmission.

In some embodiments, the set of suitability conditions may include: A) an indication of an object (or target) of interest to be monitored via radio sensing; B) an indication of an area of interest to be monitored via radio sensing; C) an indication of an angle (or angular region) of interest to be monitored via radio sensing; D) a type of radio sensing task; or E) combinations thereof.

In certain embodiments, the indication of the object (or target) of interest includes one or more of: A) a target location (e.g., defined using a coordinate system known to the candidate device); B) a target boundary location (e.g., potential object/target location defined according to a coordinate system known to the candidate device); C) a definition of the target of interest according to a QCL type-D assumption (e.g., with respect to a signal known to the candidate device); D) an object identifier number (e.g., when the object/target is already known to the candidate device); E) an area of interest defined using angular and/or directional information (e.g., according to a coordinate system known to the candidate device); F) an area of interest defined using a QCL type-D assumption (e.g., with respect to a signal known to the candidate device); G) an area identifier number of an area of interest associated with the object/target (e.g., when the area of interest is already known to the candidate device); or H) combinations thereof.

In some embodiments, the query message includes a sensing suitability query, and the response message includes a suitability report (e.g., a radio sensing scenario suitability report). In such embodiments, the first method may further include receiving, from the network node, a reporting configuration for the suitability report, where the reporting configuration may include: A) a set of time-frequency resources to use to transmit the suitability report; B) a set of beams to use to transmit the suitability report; C) a type of report for the suitability report based on the set of suitability conditions; or D) combinations thereof.

In certain embodiments, the set of suitability conditions includes at least one of: A) a position stationarity condition of the candidate device over an indicated time duration; B) a velocity stationarity condition of the candidate device over the indicated time duration; C) an orientation stationarity condition of the candidate device over the indicated time duration; D) a minimum synchronization accuracy; E) an observability condition of an area of interest; F) an observability condition of an object of interest; G) a minimum storage capability for radio sensing measurements; H) a minimum processing capability for radio sensing measurements; I) a minimum energy storage for radio sensing measurements; or J) combinations thereof.

In one embodiment, the object and/or area of interest observability is determined based on an evaluation of a LoS reception from a beam identified with a QCL type-D assumption with respect to a signal known to the candidate device. In another embodiment, the object and/or area of interest observability is determined based on an evaluation of a NLoS reception from the beam identified with the QCL type-D assumption. In certain embodiments, the set of suitability conditions includes an indication of a QCL type-D assumption with respect to a signal known to the candidate device.

In certain embodiments, the set of suitability conditions is indicated via an index from a codebook, where the codebook includes different combinations of one or more criteria for evaluating a suitability of the radio sensing scenario. In certain embodiments, the suitability report indicates one or more suitability conditions of the set of suitability conditions which are satisfied by the candidate device. In certain embodiments, transmitting the suitability report occurs in response to determining that at least an indicated subset of the set of suitability conditions is met.

In some embodiments, the network node comprises a RAN node, where the query message includes a sensing suitability query. In some embodiments, the network node comprises a peer UE, where the query message includes a SL sensing request. In certain embodiments, the response message includes a suitability report (e.g., a radio sensing scenario suitability report). In such embodiments, the first method may include one or more of: receiving a first reporting configuration for the suitability report from the peer UE, receiving a second reporting configuration for the suitability report from the RAN node, and/or transmitting the suitability report to the RAN node.

In certain embodiments, the suitability report is based on the first reporting configuration, where the first reporting configuration may include: A) a first set of time/frequency/beam resources for transmitting the suitability report to the RAN node; B) a second set of time/frequency/beam resources for transmitting the suitability report to the peer UE; C) a first reporting type for the suitability report associated with the peer UE; D) a second reporting type for the suitability report associated with the RAN node; E) a first reporting condition (e.g., one or more RAN reporting criteria) for the suitability report associated with the RAN node; F) a reporting condition (e.g., one or more SL reporting criteria) for the suitability report associated with the peer UE; or G) combinations thereof.

In certain embodiments, the suitability report is based on the second reporting configuration, where the second configuration for the suitability report received from the RAN node may include: A) a first set of time/frequency/beam resources for reception of the query message from the peer UE; B) a second set of time/frequency/beam resources for transmitting a report to the peer UE; C) a third set of time/frequency/beam resources for transmitting a report to the RAN node; D) a first reporting type for the suitability report associated with the peer UE (e.g., based on the evaluated suitability conditions); E) a second reporting type for the suitability report associated with the RAN node (e.g., based on the evaluated suitability conditions); F) a first reporting condition (e.g., one or more SL reporting criteria) for the suitability report associate with the peer UE; G) a second reporting condition (e.g., one or more RAN reporting criteria) for the suitability report associated with the RAN node; or H) combinations thereof.

Disclosed herein is a second apparatus for identifying UEs to participate in a radio sensing operation, according to embodiments of the disclosure. The second apparatus may be implemented by a network node, such as the remote unit 105, the base station unit 121, the UE 205, the RAN node 210, the first RAN entity 301, the second RAN entity 303, the first UE 305, the RAN node 401, the UE-0 503, the UE apparatus 600, and/or the NE apparatus 700, described above. The second apparatus includes a memory coupled to a processor, the memory storing instructions executable by the processor to cause the second apparatus to: A) transmit, to a plurality of candidate devices, a query message (e.g., a sensing suitability query) for a radio sensing operation, where the query message indicates a set of suitability conditions; B) receive at least one response message from at least one of the plurality of candidate devices, each response message indicating a suitability of a particular candidate device for participation in the radio sensing operation; E) determine, based on the at least one response message, a set of (i.e., one or more) devices to participate in the radio sensing operation; D) configure the set of devices to participate in the radio sensing operation; and E) perform the radio sensing operation.

In some embodiments, to configure the set of devices, the instructions are executable by the processor to cause the second apparatus to transmit a sensing configuration for the radio sensing operation. In such embodiments, the sensing configuration may include: A) an indication of an object (or target) of interest to be monitored via radio sensing; B) an indication of an area of interest to be monitored via radio sensing; C) an indication of an angle (or angular region) of interest to be monitored via radio sensing; D) a type of radio sensing task; or E) combinations thereof.

In certain embodiments, the indication of the object (or target) of interest includes one or more of: A) a target location (e.g., defined using a coordinate system known to a respective candidate device); B) a target boundary location (e.g., potential object/target location defined according to a coordinate system known to the respective candidate device); C) a definition of the target of interest according to a QCL type-D assumption (e.g., with respect to a signal known to the respective candidate device); D) an object identifier number (e.g., when the object/target is already known to the respective candidate device); E) an area of interest defined using angular and/or directional information (e.g., according to a coordinate system known to the respective candidate device); F) an area of interest defined using a QCL type-D assumption (e.g., with respect to a signal known to the respective candidate device); G) an area identifier number of an area of interest associated with the object/target (e.g., when the area of interest is already known to the candidate device); or H) combinations thereof.

In some embodiments, the query message includes a sensing suitability query, and the response message includes a suitability report (e.g., a radio sensing scenario suitability report). In such embodiments, the instructions are executable by the processor to cause the second apparatus to transmit a reporting configuration for the suitability report to the candidate devices, where the reporting configuration may include: A) a set of time-frequency resources to use to transmit the suitability report; B) a set of beams to use to transmit the suitability report; C) a type of report for the suitability report based on the set of suitability conditions; or D) combinations thereof.

In certain embodiments, the set of suitability conditions includes at least one of: A) a position stationarity condition of a respective candidate device over an indicated time duration; B) a velocity stationarity condition of the respective candidate device over the indicated time duration; C) an orientation stationarity condition of the respective candidate device over the indicated time duration; D) a minimum synchronization accuracy; E) an observability condition of an area of interest; F) an observability condition of an object of interest; G) a minimum storage capability for radio sensing measurements; H) a minimum processing capability for radio sensing measurements; I) a minimum energy storage for radio sensing measurements; or J) combinations thereof.

In one embodiment, the object and/or area of interest observability is determined based on an evaluation of a LoS reception from a beam identified with a QCL type-D assumption with respect to a signal known to a respective candidate device. In another embodiment, the object and/or area of interest observability is determined based on an evaluation of a NLoS reception from the beam identified with the QCL type-D assumption. In certain embodiments, the set of suitability conditions includes an indication of a QCL type-D assumption with respect to a signal known to the respective candidate device.

In certain embodiments, the set of suitability conditions is indicated via an index from a codebook, where the codebook includes different combinations of one or more criteria for evaluating a suitability of the radio sensing scenario. In certain embodiments, the suitability report indicates one or more suitability conditions of the set of suitability conditions which are satisfied by the particular candidate device. In certain embodiments, the instructions are executable by the processor to cause the second apparatus to indicate a subset of the set of suitability conditions that triggers the suitability report when met.

In some embodiments, the second apparatus comprises a RAN node, wherein the query message includes a sensing suitability query. In certain embodiments, the instructions are executable by the processor to cause the second apparatus to transmit a reporting configuration for the suitability report to a respective candidate device, where the reporting configuration may include: A) a first set of time/frequency/beam resources for reception of the query message from the RAN node; B) a second set of time/frequency/beam resources for reception of the query message from a peer UE; C) a third set of time/frequency/beam resources for transmitting the suitability report to the RAN node; D) a fourth set of time/frequency/beam resources for transmitting the suitability report to a peer UE; E) a first reporting type for the suitability report associated with the peer UE (e.g., based on the evaluated suitability conditions); F) a second reporting type for the suitability report associated with the RAN node (e.g., based on the evaluated suitability conditions); G) a first reporting condition (e.g., one or more RAN reporting criteria) for the suitability report associated with the RAN node; H) a second reporting condition (e.g., one or more SL reporting criteria) for the suitability report associated with the peer UE; or I) combinations thereof.

In some embodiments, the second apparatus comprises a peer UE, where the query message includes a SL sensing request. In certain embodiments, the instructions are executable by the processor to cause the second apparatus to transmit a reporting configuration to a respective candidate device, where the reporting configuration may include: A) a first set of time/frequency/beam resources for transmitting the suitability report to a RAN node; B) a second set of time/frequency/beam resources for transmitting the suitability report to the peer UE; C) a first reporting type for the suitability report associated with the peer UE (e.g., based on the evaluated suitability conditions); D) a second reporting type for the suitability report associated with the RAN node (e.g., based on the evaluated suitability conditions); E) a first reporting condition (e.g., RAN reporting criteria) for the suitability report associated with the RAN node; F) a second reporting condition (e.g., SL reporting criteria) for the suitability report associated with the peer UE; or G) combinations thereof.

Disclosed herein is a second method for identifying UEs to participate in a radio sensing operation, according to embodiments of the disclosure. The second method may be performed by a network node, such as the remote unit 105, the base station unit 121, the UE 205, the RAN node 210, the first RAN entity 301, the second RAN entity 303, the first UE 305, the RAN node 401, the UE-0 503, the UE apparatus 600, and/or the NE apparatus 700, described above. The second method includes transmitting, to a plurality of candidate devices, a query message (e.g., a sensing suitability query) for a radio sensing operation, wherein the query message indicates a set of suitability conditions. The second method includes receiving at least one response message from at least one of the plurality of candidate devices, each response message indicating a suitability of a particular candidate device for participation in the radio sensing operation. The second method includes determining, based on the at least one response message, a set of (i.e., one or more) devices to participate in the radio sensing operation. The second method includes configuring the set of devices to participate in the radio sensing operation and performing the radio sensing operation.

In some embodiments, configuring the set of devices includes transmitting a sensing configuration for the radio sensing operation. In such embodiments, the sensing configuration may include: A) an indication of an object (or target) of interest to be monitored via radio sensing; B) an indication of an area of interest to be monitored via radio sensing; C) an indication of an angle (or angular region) of interest to be monitored via radio sensing; D) a type of radio sensing task; or E) combinations thereof.

In certain embodiments, the indication of the object (or target) of interest includes one or more of: A) a target location (e.g., defined using a coordinate system known to a respective candidate device); B) a target boundary location (e.g., potential object/target location defined according to a coordinate system known to the respective candidate device); C) a definition of the target of interest according to a QCL type-D assumption (e.g., with respect to a signal known to the respective candidate device); D) an object identifier number (e.g., when the object/target is already known to the respective candidate device); E) an area of interest defined using angular and/or directional information (e.g., according to a coordinate system known to the respective candidate device); F) an area of interest defined using a QCL type-D assumption (e.g., with respect to a signal known to the respective candidate device); G) an area identifier number of an area of interest associated with the object/target (e.g., when the area of interest is already known to the respective candidate device); or H) combinations thereof.

In some embodiments, the query message includes a sensing suitability query, and the response message includes a suitability report (e.g., a radio sensing scenario suitability report). In such embodiments, the second method may further include transmitting a reporting configuration for the suitability report to the candidate devices, where the reporting configuration may include: A) a set of time-frequency resources to use to transmit the suitability report; B) a set of beams to use to transmit the suitability report; C) a type of report for the suitability report to be transmitted based on the set of suitability conditions; or D) combinations thereof.

In certain embodiments, the set of suitability conditions may include at least one of: A) a position stationarity condition of a respective candidate device over an indicated time duration; B) a velocity stationarity condition of the respective candidate device over the indicated time duration; C) an orientation stationarity condition of the respective candidate device over the indicated time duration; D) a minimum synchronization accuracy; E) an observability condition of an area of interest; F) an observability condition of an object of interest; G) a minimum storage capability for radio sensing measurements; H) a minimum processing capability for radio sensing measurements; I) a minimum energy storage for radio sensing measurements; or J) combinations thereof.

In one embodiment, the object and/or area of interest observability is determined based on an evaluation of a LOS reception from a beam identified with a QCL type-D assumption with respect to a signal known to a respective candidate device. In another embodiment, the object and/or area of interest observability is determined based on an evaluation of a NLoS reception from the beam identified with the QCL type-D assumption. In certain embodiments, the set of suitability conditions includes an indication of a QCL type-D assumption with respect to a signal known to the respective candidate device.

In certain embodiments, the set of suitability conditions is indicated via an index from a codebook, where the codebook includes different combinations of one or more criteria for evaluating a suitability of the radio sensing scenario. In certain embodiments, the suitability report indicates one or more suitability conditions of the set of suitability conditions which are satisfied by the particular candidate device. In certain embodiments, the second method further includes indicating a subset of the set of suitability conditions that triggers the suitability report when met.

In some embodiments, the network node comprises a RAN node, where the query message includes a sensing suitability query. In certain embodiments, the second method may further include transmitting a reporting configuration for the suitability report to a respective candidate device, where the reporting configuration may include: A) a first set of time/frequency/beam resources for reception of the query message from the RAN node; B) a second set of time/frequency/beam resources for reception of the query message from a peer UE; C) a third set of time/frequency/beam resources for transmitting the suitability report to the RAN node; D) a fourth set of time/frequency/beam resources for transmitting the suitability report to a peer UE; E) a first reporting type for the suitability report associated with the peer UE (e.g., based on the evaluated suitability conditions); F) a second reporting type for the suitability report associated with the RAN node (e.g., based on the evaluated suitability conditions); G) a first reporting condition (e.g., one or more RAN reporting criteria) for the suitability report associated with the RAN node; H) a second reporting condition (e.g., one or more SL reporting criteria) for the suitability report associated with the peer UE; or I) combinations thereof.

In some embodiments, the network node comprises a peer UE, where the query message includes a SL sensing request. In certain embodiments, the second method may further include transmitting a reporting configuration to a respective candidate device, where the reporting configuration may include: A) a first set of time/frequency/beam resources for transmitting the suitability report to a RAN node; B) a second set of time/frequency/beam resources for transmitting the suitability report to the peer UE; C) a first reporting type for the suitability report associated with the peer UE (e.g., based on the evaluated suitability conditions); D) a second reporting type for the suitability report associated with the RAN node (e.g., based on the evaluated suitability conditions); E) a first reporting condition (e.g., RAN reporting criteria) for the suitability report associated with the RAN node; F) a second reporting condition (e.g., SL reporting criteria) for the suitability report associated with the peer UE; or G) combinations thereof.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a RAM, a read-only memory (“ROM”), an erasable programmable read-only memory (“EPROM”), an electronically erasable programmable read-only memory (“EEPROM”), a Flash memory, a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), WLAN, or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “at least one of A, B and C” includes only A, only B, only C, a combination of A and B, a combination of B and C, a combination of A and C or a combination of A, B and C. As used herein, “a member selected from the group consisting of A, B, and C,” includes one and only one of A, B, or C, and excludes combinations of A, B, and C. As used herein, “a member selected from the group consisting of A, B, and C and combinations thereof” includes only A, only B, only C, a combination of A and B, a combination of B and C, a combination of A and C or a combination of A, B and C.

Aspects of the embodiments are described above with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

1. A user equipment (“UE”) for wireless communication, comprising:
at least one memory; and
at least one processor coupled with the at least one memory and configured to cause the UE to:
receive, from a network node, a query message for a radio sensing operation, wherein the query message indicates a set of suitability conditions;
determine that the UE satisfies the set of suitability conditions;
transmit, to the network node, a response message based on the determination;
receive a sensing configuration for the radio sensing operation in response to the response message, the sensing configuration comprising one or more of: a configuration for radio sensing reference signal (“RS”) transmission, a configuration for radio sensing RS reception, or a configuration for radio sensing measurement report transmission; and
perform the radio sensing operation based on the sensing configuration.

2. The UE of claim 1, wherein the set of suitability conditions comprises one or more of:
an indication of an object of interest to be monitored via radio sensing,
an indication of an area of interest to be monitored via radio sensing,
an indication of an angle of interest to be monitored via radio sensing, or
a type of radio sensing task.

3. The UE of claim 2, wherein the indication of the object of interest comprises one or more of:
a target location;
a target boundary location;
a definition of the target of interest according to a quasi-co-location (“QCL”) type-D assumption with respect to a signal known to the UE;
an object identifier number;
an area of interest defined using angular and/or directional information;
an area of interest defined using a QCL type-D assumption with respect to a signal known to the UE; or
an area identifier number of an area of interest associated with the object.

4. The UE of claim 1, wherein the query message comprises a sensing suitability query, wherein the response message comprises a suitability report, wherein the at least one processor is configured to cause the UE to receive a reporting configuration for the suitability report from the network node, wherein the reporting configuration comprises one or more of:
a set of time-frequency resources for transmitting the suitability report,
a set of beams for transmitting the suitability report, or
a type of report for the suitability report based on the set of suitability conditions.

5. The UE of claim 4, wherein the suitability report indicates one or more suitability conditions of the set of suitability conditions which are satisfied by the UE.

6. The UE of claim 4, wherein the at least one processor is configured to cause the UE to transmit the suitability report based on a determination that at least an indicated subset of the set of suitability conditions is met.

7. The UE of claim 1, wherein the set of suitability conditions comprises one or more of:
a position stationarity condition of the UE over an indicated time duration;
a velocity stationarity condition of the UE over the indicated time duration;
an orientation stationarity condition of the UE over the indicated time duration;
a minimum synchronization accuracy;
an observability condition of an area of interest;
an observability condition of an object of interest;
a minimum storage capability for radio sensing measurements;
a minimum processing capability for radio sensing measurements; or
a minimum energy storage for radio sensing measurements.

8. The UE of claim 7, wherein the set of suitability conditions is indicated via an index from a codebook, where the codebook includes different combinations of one or more criteria for evaluating a suitability of a radio sensing scenario.

9. The UE of claim 1, wherein the network node comprises a base station, wherein the query message comprises a sensing suitability query.

10. The UE of claim 1, wherein the network node comprises a peer UE, wherein the query message comprises a sidelink sensing request.

11. The UE of claim 10, wherein the response message comprises a suitability report, wherein the at least one processor is configured to cause the UE to perform one or more of:
receive, from the peer UE, a first reporting configuration for the suitability report;
receive, from a base station, a second reporting configuration for the suitability report; and
transmit the suitability report to the base station.

12. The UE of claim 11, wherein the suitability report is based on the first reporting configuration, and wherein the first reporting configuration comprises one or more of:
a first set of time/frequency/beam resources for transmitting the suitability report to the base station;
a second set of time/frequency/beam resources for transmitting the suitability report to the peer UE;
a first reporting type associated with the peer UE;
a second reporting type associated with the base station;
a first reporting condition associated with the base station; or
a second reporting condition associated with the peer UE.

13. The UE of claim 11, wherein the suitability report is based on the second reporting configuration, and wherein the second reporting configuration for the suitability report received from the base station comprises one or more of:
a first set of time/frequency/beam resources for reception of the sensing configuration from the peer UE;
a second set of time/frequency/beam resources for transmitting the suitability report to the peer UE;
a first reporting type associated with the peer UE;
a second reporting type associated with the base station;
a first reporting condition associated with the base station;
a second reporting condition associated with the peer UE; or
a third set of time/frequency/beam resources for transmitting the suitability report to the base station.

14. A processor for wireless communication, comprising:
at least one controller coupled with at least one memory and configured to cause the processor to:
receive, from a network node, a query message for a radio sensing operation, wherein the query message indicates a set of suitability conditions;
determine that a candidate device satisfies the set of suitability conditions;
transmit, to the network node, a response message to the network node based on the determination;
receive a sensing configuration for the radio sensing operation in response to the response message, the sensing configuration comprising one or more of: a configuration for radio sensing reference signal (“RS”) transmission, a configuration for radio sensing RS reception, or a configuration for radio sensing measurement report transmission; and
perform the radio sensing operation based on the sensing configuration.

15. A base station for wireless communication, comprising:
at least one memory; and
at least one processor coupled with the at least one memory and configured to cause the base station to:
transmit, to a plurality of candidate devices, a query message for a radio sensing operation, wherein the query message indicates a set of suitability conditions;
receive at least one response message from at least one of the plurality of candidate devices, each response message indicating a suitability of a particular candidate device for participation in the radio sensing operation;
determine, based on the at least one response message, a set of devices to participate in the radio sensing operation;
configure the set of devices to participate in the radio sensing operation; and
perform the radio sensing operation.

16. The base station of claim 15, wherein the set of suitability conditions comprises one or more of:
an indication of an object of interest to be monitored via radio sensing,
an indication of an area of interest to be monitored via radio sensing,
an indication of an angle of interest to be monitored via radio sensing, or
a type of radio sensing task.

17. The base station of claim 15, wherein the query message comprises a sensing suitability query, wherein the response message comprises a suitability report, wherein the at least one processor is configured to cause the base station to transmit a reporting configuration for the suitability report to a user equipment (UE), wherein the reporting configuration comprises one or more of:
a set of time-frequency resources for transmitting the suitability report,
a set of beams for transmitting the suitability report, or
a type of report for the suitability report based on the set of suitability conditions.

18. The base station of claim 17, wherein the suitability report indicates one or more suitability conditions of the set of suitability conditions which are satisfied by the UE, and wherein the at least one processor is configured to cause the base station to receive the suitability report based on a determination that at least an indicated subset of the set of suitability conditions is met.

19. The base station of claim 15, wherein the set of suitability conditions comprises one or more of:
a position stationarity condition of a user equipment (UE) over an indicated time duration;
a velocity stationarity condition of the UE over the indicated time duration;
an orientation stationarity condition of the UE over the indicated time duration;
a minimum synchronization accuracy;
an observability condition of an area of interest;
an observability condition of an object of interest;
a minimum storage capability for radio sensing measurements;
a minimum processing capability for radio sensing measurements; or
a minimum energy storage for radio sensing measurements.

20. A method performed by a base station, the method comprising:
transmitting, to a plurality of candidate devices, a query message for a radio sensing operation, wherein the query message indicates a set of suitability conditions;
receiving at least one response message from at least one of the plurality of candidate devices, each response message indicating a suitability of a particular candidate device for participation in the radio sensing operation;
determining, based on the at least one response message, a set of devices to participate in the radio sensing operation;
configuring the set of devices to participate in the radio sensing operation; and
performing the radio sensing operation.
